(19) United States
(12) Patent Application Publication
(10) Pub. No.: US 2025/0373878 A1
(43) Pub. Date: Dec. 4, 2025

(54) REAL-TIME STREAMING AND PLAYBACK OF SYNCHRONIZED AUDIO AND ANIMATION DATA

(71) Applicant: NVIDIA Corporation, Santa Clara, CA (US)

(72) Inventors: Hugo Verjus, Zurich (CH); Zheng Liu, Los Altos, CA (US); Kaustubh Purandare, San Jose, CA (US)

(21) Appl. No.: 19/224,613

(22) Filed: May 30, 2025

Related U.S. Application Data
(60) Provisional application No. 63/655,071, filed on Jun. 2, 2024.

(51) Int. Cl. H04N 21/43; G06T 13/20; H04N 21/81

(52) U.S. Cl. CPC H04N 21/4307; G06T 13/205; H04N 21/8146

(57) ABSTRACT

Disclosed are apparatuses, systems, and techniques for real-time streaming and playback of synchronized audio and animation data in a web-browser, which include responsive to determining that audio data in an audio data queue satisfies a first criterion, generating a delay indicator; receiving updates to the audio data queue; and responsive to determining that the audio data in the audio data queue satisfies a second criterion, causing the audio data in the audio data queue and animation data in an animation data queue to play in accordance with the delay indicator to maintain synchronization between the audio data and the animation data.

### RELATED APPLICATIONS

This application claims the benefit of U.S. Application No. 63/655,071, filed Jun. 2, 2024, the entire contents of which are incorporated herein by reference.

### TECHNICAL FIELD

At least one embodiment pertains to systems and techniques for implementing real-time streaming and playback of synchronized audio and animation data.

### BACKGROUND

The use of machine learning models for applying artificial intelligence is emerging as a prevailing trend with the proliferation of diverse models tailored for various applications across multiple industries. However, these models cannot function in isolation, and must be integrated into data processing pipelines. These pipelines also serve as bridges between real-world data and the models, fulfilling the feeding of data into the models and the retrieval and distribution of inference results for subsequent analysis and post-processing.

The escalating complexity of this ecosystem poses challenges for both application developers and AI scientists, who must carefully fine-tune the system to achieve optimal performance by striking a delicate balance between processing, throughput, and latency.

### BRIEF DESCRIPTION OF DRAWINGS

Various embodiments in accordance with the present disclosure will be described with reference to the drawings, in which:

FIG. 1 is a block diagram of an example architecture of a computing system capable of performing real-time streaming and playback of synchronized audio and animation data, according to at least one embodiment;

FIG. 2 illustrates an example computing device that facilitates a synchronized audio and animation data playback system, according to at least one embodiment;

FIG. 3 is a flow diagram of an example method of synchronizing the real-time playback of streaming audio and animation data, according to at least one embodiment;

FIG. 4 illustrates an example workflow for synchronizing the real-time playback of streaming audio and animation data, according to least one embodiment;

FIG. 5A illustrates inference and/or training logic, according to at least one embodiment;

FIG. 5B illustrates inference and/or training logic, according to at least one embodiment;

FIG. 6 illustrates an example data center system, according to at least one embodiment;

FIG. 7 illustrates a computer system, according to at least one embodiment;

FIG. 8 illustrates a computer system, according to at least one embodiment;

FIG. 9 illustrates at least portions of a graphics processor, according to one or more embodiments;

FIG. 10 illustrates at least portions of a graphics processor, according to one or more embodiments;

FIG. 11 is an example data flow diagram for an advanced computing pipeline, in accordance with at least one embodiment;

FIG. 12 is a system diagram for an example system for training, adapting, instantiating and deploying machine learning models in an advanced computing pipeline, in accordance with at least one embodiment; and

FIGS. 13A and 13B illustrate a data flow diagram for a process to train a machine learning model, as well as client-server architecture to enhance annotation tools with pre-trained annotation models, in accordance with at least one embodiment.

### DETAILED DESCRIPTION

Existing pipelines can generate realistic human avatars in real-time that can visibly express emotion appropriate for corresponding audio content, and map that audio content with facial features to mimic pronunciation. One such platform that users can use to implement these pipelines is the Avatar Control Engine (“ACE”) from NVIDIA Corporation. An ACE-implemented pipeline takes audio input and generates facial animation data, including emotions in facial expressions. This is achieved by detecting emotions in the audio input and using the emotions as part of the input for inferencing using a machine learning model. Pipelines may be implemented as a web service that receives audio data and streams back audio and animation data in sync to a browser. The facial animation can include emotional expression, which can be generated based on emotions detected in the input audio data.

To provide this experience, a web application can connect to an artificial intelligence (AI)-implemented service endpoint in the cloud to send audio data and receive aligned animation data and audio in return. This animation data can be used to render a three-dimensional (3D) animation (e.g., avatar) with facial movements, especially lip movement in sync with the audio. Rendering a 3D model can be an expensive operation, requiring a lot of compute power. Rendering in the cloud is costly; however, conventional laptops and even mobile phones can be used to offload some or all of this computing. One of the most efficient ways to share an application is to have it run across any device. Web browsers offer this capability on almost every device through the web graphics library (WebGL).

Playing audio in a browser is traditionally a relatively easy task when the audio clip to be played is fully available by the browser. However, in real-time use cases, audio data is to be presented as soon as it is received. Additionally, the audio playback should be synchronized with the animation playback. Particularly for facial animations, any misalignment between the visual and auditory cues can break immersion, reduce realism, and negatively impact user perception. For example, when a character's facial movements, such as lip motions, jaw movements, and expressions do not match the corresponding speech, it creates an unnatural and distracting experience. Synchronization between the animation and corresponding audio can be essential for maintaining natural communication and ensuring user engagement.

Synchronizing animation and audio in a web browser, particularly when the audio and/or animation data is received over a network (e.g., from the AI-implemented service endpoint in the cloud) presents several technical challenges. For example, network latency and jitter can cause inconsistencies in the timing of data arrival. If the network experiences high latency, packet loss, or jitter, the audio stream may be delayed, buffered, or even momentarily dropped, causing the animation to continue playing ahead of the sound. This mismatch is especially problematic in applications where precise timing is crucial, such as lip-syncing in virtual characters (e.g., avatars).

Aspects and embodiments of the present disclosure address these and other challenges of synchronizing playback of audio and animation data in real-time or near real-time (e.g., without significant delay) by providing a synchronization and playback system that introduces a feedback mechanism within a local application such as a web browser to synchronize audio and animations, maintain synchronization after network issues, and handle data being streamed over time.

The synchronization system can receive animation data and corresponding audio data from a server (e.g., from an AI-implemented service endpoint in the cloud). As animation data and audio data are received, the synchronization system can store the received data in corresponding queues (e.g., store the animation data in an animation data queue, and the audio data in an audio data queue). The synchronization system can begin by storing an audio play start time, e.g., a timestamp corresponding to the initiation of the audio playback. The synchronization system can read the audio data from the audio data queue, and in response to determining that there is insufficient data in the audio data queue (e.g., in response to determining the amount of data in the queue is below a threshold), the synchronization system can generate a delay indicator. The delay indicator can indicate a time delay (e.g., milliseconds) for which to pause the corresponding animation in order to keep the animation and audio synchronized. Once there is sufficient data in the audio data queue (e.g., in response to determining the amount of data in the queue is at or above the threshold), the synchronization system can read the audio data from the audio data queue, and cause the audio data to play. Simultaneously, the synchronization system can determine when to apply the animation data in the animation data queue according to the stored audio play start time and the audio delay indicator. That is, the synchronization system can pause the animation playback until it determines that the time delay in the delay indicator has elapsed, and can then proceed to read the animation data from the animation data queue and apply the read animation data to the animation. The synchronization system can identify the end of the playback, and cause the animation data and audio data playback to stop in response to determining that the end of the playback has been met.

In some embodiments, one or more processors (e.g., of a client device) can cause the synchronized presentation of audio data (e.g., from an audio data queue) with animation data (e.g., from an animation data queue). The synchronized presentation can be presented in accordance with the delay indicator that is computed in response to determining that the audio data in the audio data queue satisfies a first criterion (e.g., that the amount of data in the queue is below a threshold). The delay indicator can be updated in response to determining that the audio data in the audio data a queue satisfies a second criterion after the audio data queue has been updated with new audio data. The second criterion can be satisfied if the amount of data in the queue is equal to or above a threshold, for example.

In some embodiments, the synchronization system can implement a feedback mechanism between two contexts running in the local application (e.g., web browser). A context refers to an execution environment associated with a component of the application. A context can manage and provide access to shared resources. One context can correspond to a main context (e.g., a main JavaScript context, a main WebAssembly (WASM) context, or a main context corresponding to any other programming language). In addition to JavaScript, modern browsers support a wide range of languages through WASM, including but not limited to C, C++, Rust, Go, TypeScript, Python, C#, .NET, and many others, with varying levels of production stability. For native applications, essentially any programming language can be used to implement the main context. The other context can be a secondary context associated with audio (e.g., corresponds to an AudioWorklet context, or corresponding to an audio streaming replay in any programming language). The secondary context can enable execution of custom audio processing code in a dedicated audio rendering environment to achieve low-latency, high-performing audio processing within the application (e.g., the browser). The feedback mechanism enables the main context and the secondary context to send and receive messages. One or more threads can operate within a context. A thread can refer to a unit of execution. In some embodiments, the main context can manage multiple threads, e.g., one thread that receives data (e.g., from a server), one thread that receives messages (e.g., from the secondary context), and one thread that plays animation data. The secondary context can manage multiple threads, e.g., one thread to process messages (e.g., received from the main context), and another thread to play audio data. In some embodiments, the main context can receive animation data, and optionally the corresponding audio data, e.g., from an AI-implemented service endpoint in the cloud. In some embodiments, the AI-implemented service endpoint can receive audio data, and can send back animation data that corresponds to the audio data as well as the audio data. In some embodiments, the AI-implemented service endpoint can receive a textual prompt, and can send back animation data and audio data that corresponds to the textual prompt. In some embodiments, the audio data can be received from another source, and/or stored on the device implementing the synchronization system.

The main context (e.g., via its first thread) can send the audio data received from the server to the secondary context, and the secondary context (e.g., via its first thread) can store the audio data in an audio data queue. The main context (e.g., via its first thread) can store the animation data received from the server in an animation data queue. The main context can continue to send audio data to the secondary context and store animation data as it is received from the server until an end of data indication is received from the server.

The secondary context (e.g., via its second thread) can initiate audio playback, and can send an audio play start time message indicating an audio play start time to the main context. The main context (e.g., via its second thread) can store an audio play start time, as indicated in the audio play start time message. The secondary context (e.g., via its second thread) can read the audio data in the audio data queue. In response to determining that there is insufficient audio data in the queue (e.g., in response to determining that the amount of audio data in the queue is below a threshold), the secondary context (e.g., via its second thread) can play silent audio and can send an audio delay message to the main context indicating an audio delay. In some embodiments, the audio delay can indicate an amount of time (e.g., milliseconds) that the audio is delayed. In response to the determining that there is sufficient audio data in the queue (e.g., in response to determining that the amount of audio data in the queue is equal to or above the threshold), the secondary context (e.g., via its second thread) can cause the audio data to play. The secondary context can then determine if an end-of-playback indication has been received. If so, the secondary context can send a message to the main context to indicate the end of playback. If not, the secondary context can read the next audio data in the audio queue, and continue to play audio (if there is sufficient audio data in the queue) or play silence (if there is insufficient audio data in the queue).

Upon receiving the audio delay message from the secondary context, the main context (e.g., via its second thread) can store the audio delay. The audio delay can be used to push back the timing of applying the animation data on the animation (e.g., on a three-dimensional (3D) animation model). Upon receiving end-of-playback message from the secondary context, the main context (e.g., via its second thread) can store a end-of-playback indicator.

Upon initiating play of the animation on the 3D animation model, the main context (e.g., via its third thread) can determine whether to play the next animation data from the animation data queue according to the audio play start time and the audio delay indicator. That is, the main context can pause the animation until the audio delay indicator applied to the audio play start time has elapsed. Upon determining that the audio delay indicator has elapsed, the main context can read the animation data from the animation data queue and apply the animation data on the 3D animation model. The main context (e.g., via its third thread) can determine whether an end-of-playback indication has been received. If so, the main context can end the animation. If not, the main context can go to the next animation data in the queue (e.g., the next frame in the animation), and can continue playing the animation data in animation data queue in accordance with the audio delay indicator. That is, as the secondary context continues to either play silence and send an audio delay indicator, or play the audio, the main context can continue to play the animation in accordance with the audio delay indicator.

The advantages of the disclosed embodiments include, but are not limited to, improved synchronization of playback of audio and animation data as they are received. By partitioning the workload between contexts, with each context running dedicated threads of receiving data, sending and/or receiving messages, and managing data queues, the synchronization system described herein provides audiovisual alignment by pausing animation until audio can resume, thereby reducing and/or eliminating perceptible drift. Additionally, embodiments described here enable uninterrupted playback by inserting silence rather than stalling the render pipeline, which can avoid audible glitches in the playback. Embodiments described herein provide a seamless user experience by maintaining synchronized playback after network issues, such as variable bandwidth and jitter. The synchronization and playback system described herein can enable interactive avatars and chatbots to perform consistently with low latency on a variety of client devices, by not relying on resource-heavy cloud rendering. The synchronization and playback system provides robust, cross-platform, and synchronization of audio and animation playback even under challenging networking conditions.

The systems and methods described herein may be used for a variety of purposes, by way of example and without limitation, these purposes may include systems or applications for machine control, machine locomotion, machine driving, synthetic data generation, model training, perception, augmented reality, virtual reality, mixed reality, robotics, security and surveillance, autonomous or semi-autonomous machine applications, deep learning, environment simulation, data center processing, conversational AI, light transport simulation (e.g., ray tracing, path tracing, etc.), collaborative content creation for 3D assets, digital twin systems, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine, unautomated vehicles that are manually operated), systems implemented using a robot, aerial systems, medical systems, boating systems, smart area monitoring systems, systems for performing deep learning operations, systems for performing simulation operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for generating or maintaining digital twin representations of physical objects, systems implemented at least partially using cloud computing resources, and/or other types of systems.

Approaches in accordance with various embodiments can be used to generate one or more parameters for a content generation environment. In at least one embodiment, a trained machine learning (ML) and/or artificial intelligence (AI) system, such as a large language model (LLM) or a vision language model (VLM), may be used to generate parameters for the content generation environment, such as, but not limited to, camera settings, scene lighting, video parameters, and/or the like, used for displaying objects within a scene. The parameters may be based on an input provided by a user or a proxy for a user to a trained language model (e.g., LLM, VLM, etc.) that can then generate one or more settings in accordance with the input. Various embodiments may be used to generate settings in two-dimensional (2D) or three-dimensional (3D) settings. For embodiments that incorporate one or more language models—that is, one or more LLMs, one or more VLMs, or a combination of LLMs and VLMs, the language model(s) may receive an input (e.g., a prompt, a request, a query, etc.) that is parsed or otherwise formatted to generate a deterministic output. For example, the input provided to the language model may include a particular format for the output results, an example of desired output results, a particular list of parameters and their respective formatting, and the like. An input generator (e.g., a prompt generator), which may be driven or otherwise guided by one or more AI and/or ML systems, may be used to generate this input based on an initial input received from a user, a device, a proxy, and/or the like. A modified input generated by the input generator may then be provided to the language model, which will generate an output set of parameters. This output may be further evaluated with a reviewer, or other system, to ensure that the output is appropriate. Thereafter, a configuration file may be generated and/or the parameters may be directly provided to an environment to configure different components (e.g., camera settings, lighting, etc.) based on the parameters generated by the language model.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

In some embodiments, the systems and methods described herein may be performed within a simulation environment (e.g., NVIDIA's DriveSIM) using simulated data (e.g., simulated sensor data of simulated sensors of a virtual or simulated machine). For example, simulated sensor data and/or map data may be used to identify regions of interest (e.g., parking spaces) and sub-regions of interest (e.g., sub-regions of a parking space that includes a curb, wheel stop, etc.) within the simulation environment, and may use this information to perform operations (e.g., parking) associated with the virtual machine within the environment. These simulated operations may be used to test performance of the underlying algorithms, systems, and/or processes prior to deploying them in the real-world. In some instances, the simulation may be used to generate synthetic training data—e.g., training data including regions of interest and/or sub-regions of interest from within the simulation. The synthetic training data (in addition to or alternatively from real-world data) may then be processed to determine geometry and/or other information related to regions of interest, such as parking spaces or pallet delivery locations within a warehouse, for example. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

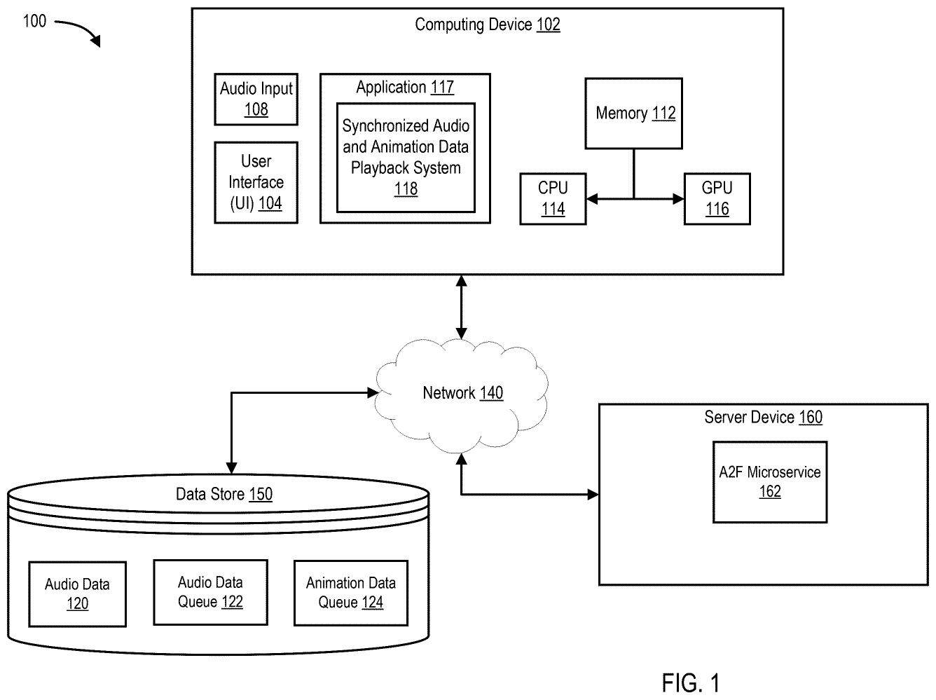

FIG. 1 is a block diagram of an example architecture of a computing system 100 capable of performing real-time streaming and playback of synchronized audio and animation data, according to at least one embodiment. The system architecture 100 (also referred to as “system” herein) can include one or more computing device(s) 102, a server device 160, and/or a data store 150, where any, some, or all of which may be connected via a network 140. It should be noted that system 100 can additionally or alternatively include other components (e.g., one or more server machines, data store(s), etc.) connected to computing device 102, etc., via network 140. In implementations, network 140 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some embodiments, data store 150 is a persistent storage that is capable of storing data as well as data structures to tag, organize, and index the data. Data store 150 can be hosted by one or more storage devices, such as main memory, magnetic or optical storage based disks, tapes or hard drives, NAS, SAN, and so forth. In some implementations, data store 150 can be a network-attached file server, while in other embodiments data store 150 can be some other type of persistent storage such as an object-oriented database, a relational database, and so forth, that may be hosted by computing device 102 or one or more different machines coupled to computing device 102 via network 140. In some embodiments, data store 150 can include audio data 120, audio data queue 122, and/or animation data queue 124. In some embodiments, audio data 120 and/or the audio data stored in audio data queue 122 can include digital representations of sound, including time-domain, frequency-domain, and/or encoded representations. The audio data can be stored, transmitted, or processed in a variety of formats. In some embodiments, the animation data stored in animation data queue 124 can include digital representations of time-varying visual content, including motion, transformation, and visual state changes of one or more graphical elements. In some embodiments, the animation data can define a set of values corresponding to visual properties (e.g., position, rotation, scale, opacity) of a graphical object at specific point in time, skeletal animation information, morph target or blend shape information, timing metadata (such as frame rate, duration, or presentation timestamps), and/or algorithmic descriptions of motion. In some embodiments, the animation data can include data that can be applied to an existing three-dimensional model, e.g., to generate or modify an animated representation of the model. As an illustrative example, the animation data can include multiple animation frames, including blend shapes that can be applied to an existing 3D mesh to modify different aspects of the 3D model. For example, the 3D mesh can correspond to a face, and the animation data can be applied to change the expression of the face.

Computing device 102 may include a computing device, a desktop computer, a laptop computer, a smartphone, a tablet computer, a server, a wearable device, a virtual/augmented/mixed reality headset or head-up display, a digital avatar or chatbot kiosk, and/or any other suitable computing device capable of performing the techniques described herein. Computing device 102 may be configured to communicate with user via user interface (UI) 104. The user may be an individual user (e.g., an owner or user of a computer, vehicle, machine, entertainment equipment), a collective user (e.g., a business organization, an institution, a government agency, and/or the like), an agent of a repair facility, and/or the like.

UI 104 may include one or more devices of various modalities, e.g., a keyboard, a touchscreen, a touchpad, a writing pad, a graphical interface, a mouse, a stylus, and/or any other pointing device capable of selecting words/phrases that are displayed on a screen, and/or some other suitable device. In some embodiments, UI 104 may include an audio device, e.g., a microphone, a speaker, or a combination thereof, a video device, such as a digital camera to capture an image or a sequence of two or more images (e.g., frames), a display device (e.g., a display for an infotainment system in a machine (such as a vehicle), a dashboard display in a machine, etc.), or a combination thereof. In some embodiments, text, speech, and/or video input devices may be integrated together (e.g., into a smartphone, tablet computer, desktop computer, automobile infotainment system, and/or the like).

In some embodiments, computing device 102 can include an audio input 108 that can receive audio from an audio sensor that can capture audio. An audio sensor can be, for example, a microphone, such as dynamic microphones, condenser microphones, ribbon microphones, unidirectional microphones, omnidirectional microphones, and/or any other types of microphone. In some embodiments, a microphone can be combined with other devices, e.g., computers, phones, speakers, TV screens, and/or the like. The audio data collected by the audio sensors may be generated, e.g., spoken, by any number of speakers and may include a single speech episode or multiple speech episodes. In some embodiments, the audio input 108 can store collected audio data in memory 112, and/or in audio data 120 of data store 150. Thus, audio input 108 can receive audio of a user of computing device 102 speaking into a microphone, for example. As an illustrative example, the user can provide speech for an animation, or can interact with a chatbot or avatar. Audio data can represent any audio sounds, such as spoken word, music, ambient sounds, sound effects, animal sounds, machine or mechanical sounds, and so on. In some embodiments, audio data 120 of data store 150 can include audio data that was previously generated and/or received. For example, audio data 120 of data store 150 can store data received form server device 160.

In some embodiments, computing device 102 can include or implement an application 117, such as a web browser, a desktop application, a mobile application (e.g., a smartphone or tablet application), etc. Application 117 can include or implement a synchronized audio and animation data playback system 118 that performs real-time (or near real-time, e.g., without significant delay) streaming and playback of synchronized audio and animation data. The synchronized audio and animation data playback system 118 may be configured to synchronize audio content with visual content (e.g., animation data). The audio content and/or visual content may be remotely generated, and may be received from one or more remote locations, such as from server device 160 and/or other remote device. In some embodiments, audio content is sent to the server device 160, which may generate visual content therefrom and send the visual content back to computing device 102. In some embodiments, the server device 160 can also send audio content back to the computing device 102 in addition to visual content. For example, the server device 160 may have modified the audio content to match the visual content. In some embodiments, the server device 160 can generate new audio content to send back to the computing device 102 along with the animation content. For example, the audio content sent to the server device 160 can be a user interaction with an avatar, and the server device 160 can generate audio content of a response to the interaction along with animation content to animate the avatar providing the response. In some embodiments, application 117 can send an instruction to generate audio and animation data, and the remote device (e.g., server device 160) can send back audio and animation data. For example, the instruction can correspond to a user interaction with a chatbot, e.g., via text.

In some embodiments, synchronized audio and animation data playback system 118 can provide audio data (e.g., stored in memory 112 and/or as audio data 120 of data store 150) to a server device 160. In some embodiments, the audio data can correspond to speech provided by a user, e.g., for an animation, or as an interaction with a chatbot or avatar. Server device 160 can include and/or implement an AI model that can receive, as input, audio, and provide, as output, animation data corresponding to the audio data. The animation data can represent any animations, such as character animation, facial animation, scene or environmental animation, user interface animation, text animation, and so on.

In some embodiments, synchronized audio and animation data playback system 118 supports an audio2face (A2F) web experience, which can enable users to preview and interact with facial animations in a local application such as a web browser. The synchronized audio and animation data playback system 118 can enable the local application (e.g., web browser) to connect with a cloud-hosted A2F microservice endpoint, e.g., A2F microservice 162. The synchronized audio and animation data playback system 118 can send user-provided audio data (e.g., audio data 120) to the A2F microservice 162. The A2F microservice 162 can process the audio and generate two data streams. The first data stream can be processed audio, which may be different from the original audio. The second data stream can be the corresponding facial animation data that drives a three-dimensional avatar's expressions and lip movements. The synchronized audio and animation data playback system 118 can render the 3D avatar in real time by animating the face in sync with the streamed audio.

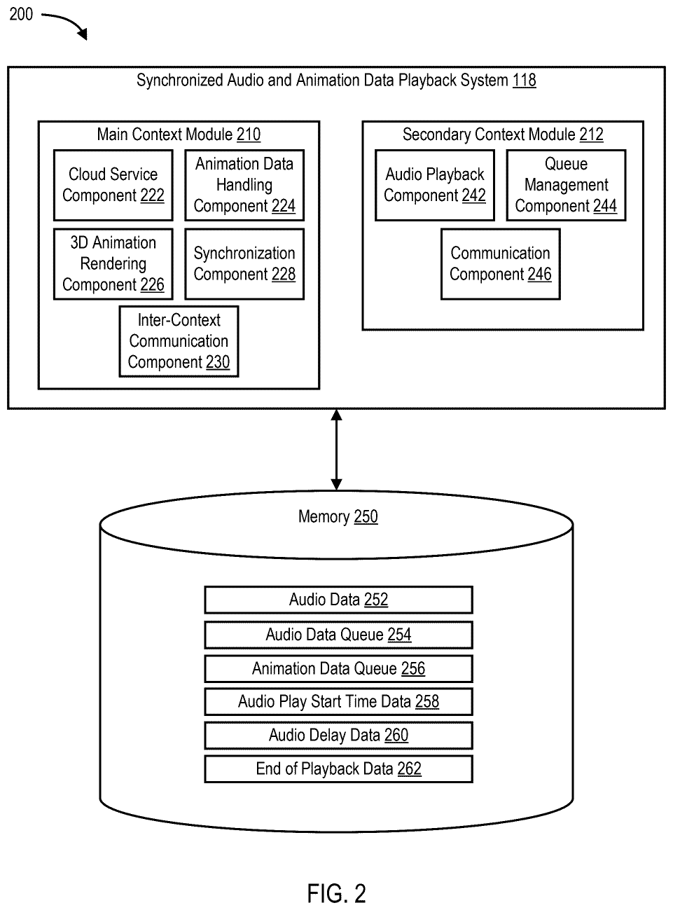

In some embodiments, synchronized audio and animation data playback system 118 can receive audio data and animation data from server device 160. In some embodiments, synchronized audio and animation data playback system 118 can store the received audio data and animation data in audio data queue 122 of data store 150 and in animation data queue 124 of data store 150, respectively. The synchronized audio and animation data playback system 118 can synchronize the streaming and playback of the audio data queue and the animation data queue. The synchronized audio and animation data playback system 118 is further described with respect to FIG. 2.

In some embodiments, synchronized audio and animation data playback system 118 can send, to server device 160, a text-based and/or audio-based prompt. Server device 160 can include and/or implement an AI model that can receive, as input, the text-based and/or audio-based prompt, and can provide, as output, a response to the prompt. In some embodiments, server device 160 can convert the audio-based prompt to text, and provide the converted prompt to the AI model. The AI model can provide, as output, a text-based response, and the server device 160 can convert the text-based response to audio. In some embodiments, server device 160 can provide the audio-based prompt to the AI model as input, and receive, as output, an audio-based response. In some embodiments, the server device 160 can provide the text-based prompt as input to the AI model, and received, as output, an audio-based response. The server device 160 can provide the audio-based response (either provided as output from the AI model or converted from a text-based response provided as output form the AI model) to the audio2face microservice 162.

In some embodiments, server device 160 can include and/or implement an audio2face (A2F) microservice 162. The A2F microservice 162 can generate animation that is representative of one or more characters uttering speech represented by audio data. Thus, the A2F microservice 162 can provide animation data corresponding to the audio data, e.g., as received from computing device 102 and/or as received as output from the AI model. In some embodiments, the A2F microservice 162 can include and/or implement one or more deep neural networks that can take as input raw audio, extract features from the raw audio, and receive one or more component vectors with which a character or scene is to be animated from the input raw audio. The one or more deep neural networks can provide output, such as motion, vertex, and/or deformation data, that can be provided to a rendered, for example, in order to generate or synthesize, for example, the facial animation corresponding to that portion of the speech. The motion or deformation information output by the network can correspond to a set of facial (or other body) and/or scenery components or portions that can be animated, at least somewhere independently, to realistically represent the particular scene (e.g., the character uttering input speech). For example, these components can include a head, jaw, eyeballs, tongue, and/or skin of the character. In embodiments, in addition to or alternatively from facial components or portions, body components or portions, such as arms, legs, torso, neck, etc., may be modeled. The A2F microservice 162 can provide 3D animation data with variable emotion control. In some embodiments, the A2F microservice 162 can detect emotion from the speech, and/or can receive emotion inputs from computing device 102. The animation data provided by A2F microservice 162 can reflect the detected and/or provided emotions.

In some embodiments, the server device 160 can include and/or implement a microservice (not pictured) that can generate animation not limited to a character uttering speech represented by audio data. The microservice can generate any type of animation, such as dancing animations, full-body animations, animal animations, color patterns, scenery, etc. The generated animations can correspond to input provided by computing device 102, such as audio and/or text input. The microservice can generate audio corresponding to the animation, such as music, ambient noise, noise from nature, animal sounds, etc. It should be noted that the A2F microservice 162 is provided as an example, and that the server device 160 can generate and/or provide any type of audio and/or animation data to computing device 102.

In some embodiments, synchronized audio and animation data playback system 118 can receive the audio data and/or the animation data from the server device 160. The synchronized audio and animation data playback system 118 can store the received animation data in the animation data queue 122 of data store 150, and can store the received audio data in audio data queue 124 of data store 150. The synchronized audio and animation data playback system 118 can implement a feedback mechanism within a web browser to synchronize the playback and/or streaming of the audio and animation in the audio data queue 122 and the animation data queue 124 as it is received from the server device 160.

In order to synchronize the playback and/or streaming of the audio and animation, the synchronized audio and animation data playback system 118 can implement a main context and a secondary context (e.g., AudioWorklet context) within the local application (e.g., web browser). The synchronized audio and animation data playback system 118 can use the main context to cause playback of the animation data in the animation data queue, and the synchronized audio and animation data playback system 118 can use the secondary context to cause playback of the audio data in the audio data queue. The synchronized audio and animation data playback system 118 can enable communication between the main context and the secondary context. The communication enables the synchronized audio and animation data playback system 118 to momentarily pause the playback of the audio and animation data to synchronize the playback of the audio and animation data. The momentary pause of the audio and animation playback can keep synchronization between the audio and animation playback in the event of network issues (e.g., in case of issues with network 140, including for example communication problems with the remote audio2face microservice 162). For example, as audio data and/or animation data is being streamed from server device 160, any delay in communication between computing device 102 and server device 160 can result in an asynchronous playback of audio and animation data. As an illustrative example, in the event of network issues, computing device 102 may receive audio data before receiving animation data from server device 160, and thus playing the audio data as it is received would result in an asynchronous playback of the audio and animation data. As another example, the synchronized audio and animation data playback system 118 can play audio data stored on computing device 102 as the corresponding animation data is being streamed from server device 160. The feedback mechanism between the main context and the secondary context implemented by the synchronized audio and animation data playback system 118 enables a momentary pause in the event of network issues or delay in receiving audio data and/or animation data, thus resulting in the synchronous playback of audio data and/or animation data streamed from server device 160. The main context and the secondary context, and the communication therebetween, are further described with respect to FIGS. 2-4.

In some embodiments, computing device 102 can include a memory 112 (e.g., one or more memory devices or units) communicatively coupled to one or more processing devices, such as one or more central processing units (CPU) 114, one or more graphics processing units (GPU) 116, one or more data processing units (DPU), one or more parallel processing units (PPUs), and/or other processing devices (e.g., field-programmable gate arrays (FPGAs), application-specific integrated circuits (ASICs), and/or the like). Memory 112 may include a read-only memory (ROM), a flash memory, a dynamic random-access memory (DRAM), such as synchronous DRAM (SDRAM), a static memory, such as static random-access memory (SRAM), and/or some other memory capable of storing digital data. In some embodiments, synchronized audio and animation data playback system 118 may download audio data 120, audio data queue 122, and/or animation data queue 124, and store them in memory 112 and/or an onboard data store. One or more CPU 114 and/or GPU 116 of computing device 102 may execute logic for synchronized audio and animation data playback system 118 to synchronize playback of the animation data queue 124 and the audio data queue 122.

FIG. 1 is an example architecture of a computing system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

FIG. 2 is a block diagram of example computing device that facilitates a synchronized audio and animation data playback system 118, according to at least one embodiment. In some embodiments, synchronized audio and animation data playback system 118 can include software, hardware, and/or firmware configured to perform on or more operations with respect to performing the real-time (or near real-time) streaming and playback of synchronized audio and animation data techniques described herein. In some embodiments, synchronized audio and animation data playback system 118 can be connected to memory 250. In some embodiments, memory 250 can correspond to memory 112 of FIG. 1. In some embodiments, memory 250 can correspond to one or more portions of data store 150 of FIG. 1. In additional or alternative embodiments, memory 250 can correspond to any memory of, connected to, or accessible by a component of system 100 of FIG. 1.

In some embodiments, the synchronized audio and animation data playback system 118 can include a main context module 210 and/or secondary context module 212 (e.g., an Audio Worklet context module). In some embodiments, memory 250 can store audio data 252, audio data queue 254, animation data queue 256, audio play start time data 258, audio delay data 260, and/or end of playback data 262. In some embodiments, the operations described with reference to main context module 210 and/or secondary context module 212 can be divided into additional modules and/or combined into a reduced number of modules. Each module 210-212 can represent a software program hosted by a device (e.g., device 102 of FIG. 1).

In some embodiments, main context module 210 can be a software program hosted by a device (e.g., device 102 of FIG. 1) configured to playback animation data in sync with audio playback. In some embodiments, the secondary context module 212 can be a software program hosted by a device (e.g., device 102 of FIG. 1) configured to playback audio data in sync with animation playback.

In some embodiments, main context module 210 can include a cloud service component 222, an animation data handling component 224, a 3D animation rendering component 226, a synchronization component 228, and/or an inter-context communication component 230. Each of the cloud service component 222, the animation data handling component 224, the 3D animation rendering component 226, the synchronization component 228, and/or the inter-context communication component 230 can include a software program (or a subset thereof) hosted by a device (e.g., device 102 of FIG. 1) that performs certain functionality of the main context module 210. The cloud service component 222, the animation data handling component 224, the 3D animation rendering component 226, the synchronization component 228, and/or the inter-context communication component 230 can be combined together or separate into further components, according to a particular implementation. It should be noted that in some implementations, various components of the main context module 210 can run a separate machine. In some embodiments, each of the components 222-230 can be or include logic configured to perform a particular action or set of actions.

In some embodiments, the cloud service component 222 can establish and maintain a connection with the cloud-based microservice, e.g., A2F microservice 162 of server device 160 of FIG. 1. The cloud service component 222 can send audio data (e.g., audio data 252, which can correspond to audio data 120 of FIG. 1) to server device 160. The cloud service component 222 can receive, from server device 160, an audio data stream and corresponding animation data stream. The animation data can represent facial animation data that corresponds to the audio data, e.g., as generated and/or provided by the A2F microservice 162. The cloud service component 222 can continue receiving audio and animation data, and can determine when the end of the audio and animation has been reached. Upon reaching the end of the audio and animation streams, the cloud service component 222 can store an end of data indicator as end of playback data 262.

In some embodiments, the animation data handling component 224 can store the received animation data as animation data queue 256. In some embodiments, the animation data handling component 224 can process the received animation data to prepare the animation data for rendering. For example, the animation data handling component 224 can parse, buffer, and/or sequence the animation data frames to ensure smooth playback.

In some embodiments, the 3D animation rendering component 226 can coordinate the rendering of a 3D animation, e.g., by applying the received animation data to an existing 3D model. For example, the 3D model can include a mesh that defines the surface geometry of the model, as well as a corresponding internal framework for articulating the model. The animation data in the animation data queue 256 can define a sequence of transformations (such as translations, rotations, and/or scalings) associated with the framework over time. The 3D animation rendering component 226 can apply the animation data in the animation data queue 256 by mapping the animation data to the corresponding elements of the internal framework. During playback or rendering, the 3D animation rendering component 226 can iteratively apply the transformations defined in the animation data to the internal framework at specified time intervals.

In some embodiments, in additional to the user of transformations such as translations, rotations, and scalings applied to the internal framework of a 3D model, some embodiments, can utilize blend shapes (sometimes referred to as morph targets) to achieve facial animation and expression. For example, a set of facial blend shapes can represent specific facial movements and expressions, such as eyebrow raises, eye blinks, mouth movements, and cheek puffs, for example. Each blend shape can correspond to a particular deformation of the model's mesh, and the animation data can specify the intensity or weight of each blend shape at any given time When rendering a 3D animation, the 3D animation rendering component 226 can apply the animation data by adjusting the weight of these blend shapes, causing the mesh to deform accordingly. This process can enable expressive and nuanced facial animations, as the blend shapes can be combined in real time to reflect complex expressions. Thus, in some embodiments, the animation data may include not only transformations for the internal framework but also blend shape weights, which are mapped to the corresponding blend shapes of the 3D model to produce lifelike facial expressions and movements.

In some embodiments, the synchronization component 228 can initiate and/or control the playback of the animation data to be in sync with the playback of the audio data. The synchronization component 228 can monitor the audio delay data 260, and can cause playback of the animation data to be paused until the delay indicator in the audio delay data 260 has been reached. For example, the synchronization component 228 can add the delay indicator of audio delay data 260 to the audio start time of audio play start time data 258 to determine when to cause playback of the animation data to resume. The synchronization component 228 can instruct the 3D animation rendering component 226 to pause and/or resume playback of the animation data, as determined using the audio delay data 260.

In some embodiments, the inter-context communication component 230 can implement a message passing interface with the secondary context module 212. The inter-context communication component 230 can send message to and/or receive messages from the secondary context module 212. The inter-context communication component 230 can send messages to the secondary context module 212 including the received audio data, as the audio data is being received. In some embodiments, the inter-context communication component 230 can send a message including the audio data to secondary context module 212 at certain intervals and/or as audio data is received. In some embodiments, the inter-context communication component 230 can send a message to the secondary context module 212 indicating the end of the audio and animation streams, e.g., stored as end of playback data 262.

The inter-context communication component 230 can receive messages from the secondary context module 212. The inter-context communication component 230 can receive a message from the secondary context module 212 that indicates the time of the initiation of the audio playback. The inter-context communication component 230 can store the indication of the initiation time of audio playback as audio play start time data 258. The inter-context communication component 230 can receive a message from secondary context module 212 that includes an audio delay indicator, and can store the audio delay as audio delay data 260. The inter-context communication component 230 can receive a message from the secondary context module 212 that includes an indicator that the audio has reached the end of playback, and can store the indicator as end of playback data 262.

In some embodiments, secondary context module 212 can include an audio playback component 242, a buffer management component 244, a communication component 246, and/or a synchronization component 248. Each of the audio playback component 242, the buffer management component 244, the communication component 246, and/or the synchronization component 248 can include a software program (or a subset thereof) hosted by a device (e.g., device 102 of FIG. 1) that performs certain functionality of the secondary context module 210. The audio playback component 242, the buffer management component 244, the communication component 246, and/or the synchronization component 248 can be combined together or separate into further components, according to a particular implementation. It should be noted that in some implementations, various components of the secondary context module 210 can run a separate machine. In some embodiments, each of the components 242-248 can be or include logic configured to perform a particular action or set of actions.

In some embodiments, the audio playback component 242 can manage the playback of audio in real-time. Real-time can include near real-time, meaning with negligible (e.g., milliseconds or microseconds) latency or delay. In some embodiments, real-time can refer to less than a threshold amount of delay. The audio playback component 242 can initiate playback of the audio data an can store a timestamp corresponding to the initiation of audio playback as audio play start time data 258. The audio playback component 242 can read audio data from the audio data queue 254 and can determine whether the amount of data read from the audio data queue 254 satisfies a condition. In some embodiments, the predetermined condition can compare the size to a minimum size or minimum playback time. The minimum size can correspond to a minimum amount of audio data to ensure smooth playback. For example, if the amount of data read from the audio data queue 254 does not satisfy the condition, this could be due to a network jitters, a delay in the microservice, a dropped packet, and so on. Thus, the audio playback component 242 can determine to play silence rather than play incomplete audio data when the amount of data read from the audio data queue 254 does not satisfy the condition. The audio playback component 242 can cause generate a delay indicator, and store the generated delay indicator as audio delay data 260. The delay indicator can reflect an amount of time that the audio playback component 242 plays silence. The audio playback component 242 can continue to read data from the audio data queue 254 and determine whether to continue playing silence and update the audio delay indicator (e.g., audio delay data 260) and/or to resume playback of the audio when sufficient data is read from the audio data queue 254 (e.g., the amount of data read from the audio data queue 254 satisfies the condition).

In some embodiments, the queue management component 244 can maintain an audio data queue 254. In some embodiments, the audio data queue 254 can store audio data as it is received, e.g., from main context module 210 and/or from server device 160. In some embodiments, the audio data queue 254 can store a pointer to audio data that is stored elsewhere in memory. In some embodiments, the queue management component 254 can keep track of the amount of data in the audio data queue 254.

In some embodiments, the communication component 246 can send to and/or receive from messages the main context module 210. The messages can include instructions to pause, resume, or adjust playback timing. The communication component 246 can send a message to the main context module 210 including the audio play start time data 258 (e.g., indicating when the audio playback component 242 initiating playback of the audio data stored in the audio data queue 254). The communication component 246 can send the message including the audio play start time data 258 once, at initiation of the audio playback. The communication component 246 can send a message to the main context module 210 including audio delay indicator, stored as audio delay data 260. In some embodiments, the communication component 246 can send an audio delay indicator message to the main context module 210 every time the audio delay data 256 is updated, and/or at a specified interval. In some embodiments, the communication component 246 can determine when the end of the audio playback has been reached, and can send a message indicating the end of playback to the main context module 210. The end of playback indicator can be stored as end of playback data 262.

In some embodiments, the communication component 246 can receive messages from the main context module 210. In some embodiments, the communication component 246 can receive a message including audio data. The communication component 246 can notify the audio queue management component 244 of the received data, and the queue management component 244 can store the received audio data as the audio data queue 254. In some embodiments, the communication component 246 can store the received audio data as the audio data queue 254, as the audio data is received. In some embodiments, the communication component 246 can receive a message from main context module 210 indicating that the audio and animation data has reached the end. The communication component 246 can store the end of data indicator as end of playback data 262.

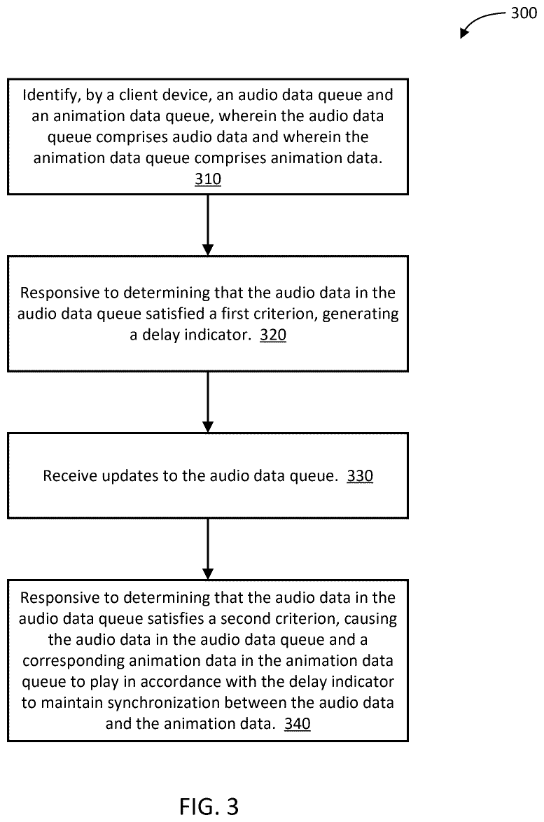

FIG. 3 is a flow diagram of an example method 300 for synchronizing the real-time (or near real-time) playback of streaming audio and animation data, according to at least one embodiment. In at least one embodiment, method 300 may be performed using processing units of computing device 102 of FIG. 1. In at least one embodiment, processing units performing method 300 may be executing instructions stored on a non-transient computer-readable storage media. In at least one embodiment, method 300 may be performed using multiple processing threads (e.g., CPU threads and/or GPU threads), with individual threads executing one or more individual functions, routines, subroutines, or operations of the methods. In at least one embodiment, processing threads implementing method 300 may be synchronized (e.g., using semaphores, critical sections, and/or other thread synchronization mechanisms). Alternatively, processing threads implementing method 300 may be executed asynchronously with respect to each other. Various operations of method 300 may be performed in a different order compared with the order shown in FIG. 3. Some operations of method 300 may be performed concurrently with other operations. In at least one embodiment, one or more operations shown in FIG. 3 may not always be performed.

Each block of method 300, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, method 300 is described, by way of example, with respect to the system of FIG. 1. However, this method may additionally or alternatively be executed by any one system, or any combination of systems, including, but not limited to, those described herein.

At block 310, method 300 may identify, by a client device (e.g., device 102 of FIG. 1) an audio data queue (e.g., audio data queue 122 of FIG. 1) and an animation data queue (e.g., animation data queue 124 of FIG. 1). The audio data queue can store audio data, and the animation data queue can store animation data. The audio data can correspond to the animation data (e.g., the animation data may include animations that correspond to portions of the audio data). The queues may be generated at block 310, or may have previously been generated and the locations of such queues (e.g., in memory and/or in a data store) may be determined at block 310. The animation data can represent a 3D animation of the audio data (e.g., a 3D animation of an avatar speaking the words in represented by the audio data, or a 3D animation of a scene represented by the sounds in the audio data). The animation data queue and the audio data queue can serve as parallel buffers for their respective data types. In some embodiments, the audio and/or animation data queue can store a reference (e.g., a memory pointer or buffer descriptor) to audio and/or animation data, respectively, that resides elsewhere in memory. As an illustrative example, audio data can represent audio from spoken words, music, poetry, sounds from nature, animal sounds, machine sounds, etc. As an illustrative example, animation data can represent facial animation, human body animation, animal animation, geometrical animation, nature scene animation, etc.

In some embodiments, the method 300 may receive the animation data from a server device (e.g., device 160 of FIG. 1). The animation data can have been generated by an AI model based on processing of the audio data (e.g., audio data 120 of FIG. 1). The method 300 can store the animation data received from the server device in the animation data queue.

In some embodiments, the method 300 may receive the audio data and the animation data from a server device (e.g., server device 160 of FIG. 1). The audio data and the animation data can have been output by an AI model based on processing of a prompt. The method 300 can store the audio data received from the server device in the audio data queue. The method 300 can store the animation data received from the server device in the animation data queue.

In some embodiments, the method 300 can receive a prompt associated with a 3D animation model. The method 300 can send the prompt to a server device (e.g., server device 160 of FIG. 1) for processing by an AI model (e.g., as described with respect to A2F microservice 162 of FIG. 1) that is trained to generate animation data for the 3D animation model. The method 300 can receive, from the server device, the animation data and corresponding audio data. The animation data and the corresponding audio data may correspond to output from the AI model. The method 300 can store the received animation data in the animation data queue, and store the received audio data in the audio data queue. In some embodiments, the prompt can be a textual prompt and/or an audio prompt.

At block 320, the method 300 may, in response to determining that the audio data in the audio data queue satisfies a first criterion, generate a delay indicator (e.g., as described with respect to audio delay data 260 of FIG. 2). The first criterion can reflect a threshold minimum size. Thus, the method 300 can determine that the audio data in the audio data queue satisfies the first criterion if the size of the audio data in the audio data queue is less than a minimum size threshold. In some embodiments, the first criterion can reflect a minimum amount of time, and the method 300 can determine that the audio data in the audio data queue satisfies the first criterion if the duration of the audio data is less than a minimum time duration threshold. The delay indicator can reflect the delay caused by the insufficient audio data in the audio data queue.

In some embodiments, in response to determining that the audio data in the audio data queue satisfies the first criterion, the method 300 can append the audio data in the audio queue with blank audio frames to cause silent audio to playback on the client device.

At block 330, the method 300 may receive updates to the audio data queue. For example, the method 300 can receive additional data, e.g., from server device 160 of FIG. 1. In some embodiments, the server 160 can send audio and/or animation data as it is generated, e.g., by A2F microservice 162.

At block 340, the method 300 may, in response to determining that the audio data in the audio data queue satisfies a second criterion, cause the audio data in the audio data queue and a corresponding animation data in the animation data queue to play in accordance with the delay indicator to maintain synchronization between the audio data and the animation data. The second criterion can reflect the size minimum, and can be satisfied if the size of the audio data in the audio data queue is equal or exceeds the minimum size threshold. For example, the method 300 can determine that the audio data in the audio data queue satisfies the second criterion if the size of the audio data in the audio data queue is equal to or greater than the minimum size threshold. In some embodiments, the second criterion can reflect a minimum amount of time, and the method 300 can determine that the audio data in the audio data queue satisfies the second criterion if the duration of the audio data is equal to or greater than the minimum time duration threshold.

In some embodiments, to cause the audio data and the corresponding animation data to play, the method 300 can apply the corresponding animation data to a 3D animation model. The 3D animation model can be provided for display in a user interface (e.g., UI 104 of FIG. 1) of the client device. The method 300 can cause the audio data to playback on the client device, e.g., through speakers connected to the client device (e.g., device 102 of FIG. 1).

In some embodiments, to cause the audio data and corresponding animation data to play in accordance with the delay indicator, the method 300 can identify, based on the delay indicator, a time delay, and can apply the time delay to a play start time associated with the audio data.

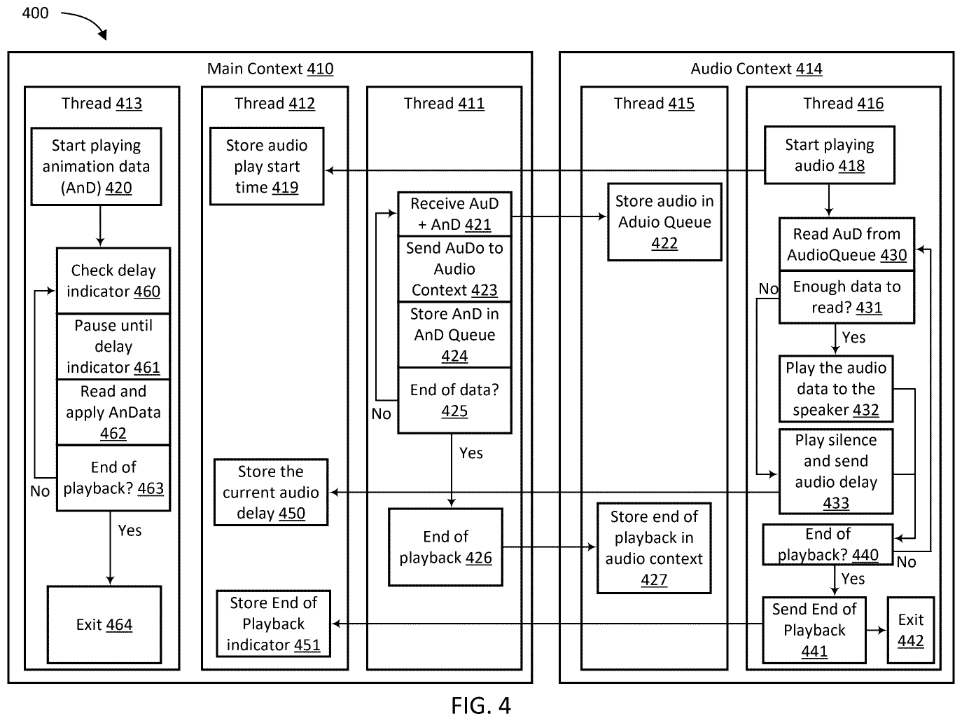

In some embodiments, the method 300 may be implemented by a web browser that includes a first context (e.g., the audio context 414 of FIG. 4) and a second context (e.g., the main context 410 of FIG. 4). The method 300 can cause the audio data in the audio data queue to play in the first context using a first thread (e.g., thread 416 of FIG. 4) and a second thread (e.g., thread 415 of FIG. 4), and can cause the animation data in the animation data queue to play in the second context using a third thread (e.g., thread 411 of FIG. 4), a fourth thread (e.g., thread 412 of FIG. 4), and a fifth thread (e.g., thread 413 of FIG. 4). In some embodiments, secondary context module 212 of FIG. 2 can be configured to implement the first context, and main context module 210 of FIG. 2 can be configured to implement the second context.

In some embodiments, the first thread of the first context of the web browser can read the audio data from the audio data queue (e.g., as described with respect to 416 of FIG. 4) and can generate the delay indicator in response to determining that the audio data in the audio data queue satisfies the first criterion (e.g., as described with respect to secondary context module 212 of FIG. 2). In some embodiments, the first thread of the first context can send, to the fourth thread of the second context, an audio delay message that includes the delay indicator (e.g., as described with respect to secondary context module 212 of FIG. 2). In some embodiments, the fourth thread of the second context can store a time delay associated with the delay indicator (e.g., as described with respect to main context module 210 of FIG. 2).

In some embodiments, the third thread of the second context of the web browser can receive the audio data and the animation data (e.g., as described with respect to main context module 210 of FIG. 2). The third thread of the second context can send the received audio data to the second thread of the first context (e.g., as described with respect to main context module 210 of FIG. 2). The second thread of the first context can store the received audio data in the audio data queue (e.g., as described with respect to secondary context module 212 of FIG. 2). The third thread of the second context can store the received animation data in the animation data queue (e.g., as described with respect to main context module 210 of FIG. 2).

In some embodiments, the first thread of the first context can cause the audio data in the audio data queue to play (e.g., as described with respect to secondary context module 212 of FIG. 2), and the fifth thread of the second context can cause the corresponding animation data in the animation data queue to play in accordance with the delay indicator (e.g., as described with respect to main context module 210 of FIG. 2).

FIG. 4 illustrates an example workflow 400 for synchronizing the real-time (or near real-time) playback of streaming audio and animation data, according to at least one embodiment. In at least one embodiment, workflow 400 may be performed using processing units of computing device 102 of FIG. 1. In at least one embodiment, processing units performing workflow 400 may be executing instructions stored on a non-transient computer-readable storage media. In at least one embodiment, workflow 400 may be performed using multiple processing threads (e.g., CPU threads and/or GPU threads), with individual threads executing one or more individual functions, routines, subroutines, or operations of the methods. In at least one embodiment, processing threads implementing workflow 400 may be synchronized (e.g., using semaphores, critical sections, and/or other thread synchronization mechanisms). Alternatively, processing threads implementing workflow 400 may be executed asynchronously with respect to each other. Various operations of workflow 400 may be performed in a different order compared with the order shown in FIG. 4. Some operations of workflow 400 may be performed concurrently with other operations. In at least one embodiment, one or more operations shown in FIG. 4 may not always be performed. In some embodiments, main context module 210 of FIG. 2 can be configured to implement main context 410, and secondary context module 212 of FIG. 2 can be configured to implement audio context 414.

In some embodiments, multiple threads can be executed within the main context 410 to orchestrate real-time (or near real-time, e.g., with negligible latency) streaming and synchronized playback of audio and animation data within a web browser, by receiving and processing data and messages from audio context 414 and by playing animation data in sync with audio playback. For example, threads 411-413 can be executed within main context 410. Thread 411 can execute instructions to receive data, e.g., from audio context 414. Thread 412 can execute instructions to receive messages, e.g., from audio context 414. Thread 413 can execute instructions to play animation data.

In some embodiments, multiple threads can be executed within the audio context 414 to play the audio and manage communication and synchronization with the main context 410. For example, threads 415-416 can be executed within audio context 414. Thread 415 can execute instructions to process messages, and thread 416 can execute instructions to play audio.

In some embodiments, the synchronized audio and animation data playback system 118 can execute workflow 400, in response to receiving audio and animation data, e.g., from server device 160. In some embodiments, thread 416 can begin by initiating playback of the received audio (418), which can include sending a message to the main context 410 indicating the audio play start time. Thread 412 can receive the message from main context 410, and can store the audio play start time (419), e.g., as audio play start time data 258 of FIG. 2.

In some embodiments, thread 413 can begin by initiating playback of the animation (420), e.g., on a 3D model such as a facial animation provided by A2F. Thread 411 can begin by receiving audio data and animation data and audio data (421), e.g., from the server device 160. In some embodiments, the animation data and audio data can correspond to facial animation data an corresponding audio, e.g., as provided by A2F microservice 162 of FIG. 1. Thread 411 can send (423) the audio data to the audio context 414, and thread 415 can store (422) the audio data in the audio data queue, e.g., audio data queue 254 of FIG. 2. Thread 411 can store (424) the animation data in animation data queue, e.g., animation data queue 256 of FIG. 2. Thread 411 can determine (425) whether it has received an end of data indicator, e.g., from server device 160. If not, thread 411 can receive additional audio and animation data (421) and continue the 421-425 loop. If an end of data indicator has been received (e.g., from server device 160), thread 411 can determine (426) that it has reached the end of playback. Thread 411 can send (426) an end of playback indicator to the audio context 414, and thread 415 can store (427) an end of playback indicator for the audio context, e.g., as end of playback data 262 of FIG. 2. In some embodiments, the end of playback indicator can be a Boolean value, where true represents the end of playback and false represents not the end of playback, for example.

In some embodiments, thread 416 of the audio context 414 can read (430) audio data from the audio data queue, e.g., audio data queue 254 of FIG. 2. Thread 416 can determine an amount of data retrieved during the read operation. For example, the read operation can return a value or data structure that reflects a quantity indicative of the size of the data retrieved. As another example, thread 416 can determine the size of the data read by inspecting metadata or headers associated with the data. In some cases, the audio data queue can store audio packets or audio frames, and each packet or frame ca include metadata specifying its size or duration, enabling thread 416 to compute the total amount of audio data read by summing the sizes or durations of the individual units retrieved from the queue. In some cases, the audio data queue can maintain timing information, such as timestamps or sample rates, enabling thread 416 to determine the playback duration represented by the audio data retrieved from the queue.

In some embodiments, thread 416 can determine (431) whether the amount of data read from the audio data queue satisfies a condition. In some embodiments, the condition can be satisfied if the amount of data read is equal to or exceeds a threshold value. In some embodiments, the threshold value can correspond to a minimum amount of data that can be played without causing a noticeable interruption in the playback. If the amount of data read from the audio data queue satisfies the condition, thread 416 can play (432) the audio data read from the audio data queue, e.g., via the speaker of a computing device 102. Thread 416 can then determine (440) whether the end of the playback has been reached. That is, thread 416 can access the end of playback indicator (e.g., stored by thread 415 at operation 427, and/or stored as end of playback data 262 of FIG. 2) to determine whether the end of playback has been reached. If the end of playback indicator indicates that the end of playback has not been reached (e.g., more audio and/or animation data is expected to be received), thread 416 can return to operation 430 and read additional data from the audio data queue, and can proceed to cycle through operations 431-440 until the end of playback indicator indicates that the end of playback has been reached. If the end of the playback has been reached, thread 416 can send (441) an end of playback message to thread 412 and can exit (442).

If, at operation 431, thread 416 determines that the amount of data read from the audio data queue does not satisfy the condition (e.g., is below the threshold value), thread 416 can play (433) silence and send an audio delay indicator to thread 412. Thread 416 can proceed to determine (440) the end of playback has been reached, and either read (430) more audio data from the audio data queue if the end of playback has not been reached or proceed to operation 441 if the end of the playback has been reached.

In some embodiments, thread 412 can receive the audio delay from thread 416 and can store (450) the audio delay, e.g., as audio delay data 260. In some embodiments, the audio delay data can reflect an amount of time that the audio data is paused until the audio data queue has sufficient data to continue playback.

In some embodiments, thread 412 can receive the end of playback message from thread 416 and can store (451) an end of playback indicator, e.g., as end of playback data 262 of FIG. 2.

Thread 413 can check (460) the delay indicator, e.g., received from thread 416 and/or stored by thread 412 as audio delay data 260. Thread 413 can pause (461) playback of the animation data until the audio delay indicator has been reached. For example, the audio delay indicator can be an amount of time, and thread 413 can pause playback of the animation data until amount of time indicated by the audio delay indicator has elapsed. Once the audio delay indicator time has elapsed (or if the audio delay data reflect no audio delay), thread 413 can read and apply (462) the animation data from the animation data queue, e.g., animation data queue 256 of FIG. 2. In some embodiments, thread 413 can apply the animation data as described with respect to 3D animation rendering component 226 of FIG. 2. Thread 413 can determine (463) whether the end of playback has been reached, e.g., by accessing the end of playback indicator (e.g., as stored by thread 412 and/or as end of playback data 262). If the end of playback has been reached, thread 413 can exit (464). If the end of playback has not been reached, thread 413 can return to operation 460 and cycle through operations 460-463 until the end of playback is reached.

The feedback mechanism in workflow 400 provides a reliable and efficient cross-platform method for synchronizing the real-time (or near real-time) playback of streaming audio and animation data, even when network delays or interruptions occur. Threads 411-416 are capable of operating independently and in parallel, allowing audio playback and processing to proceed seamlessly alongside animation and/or graphics rendering.

### Inference and Training Logic

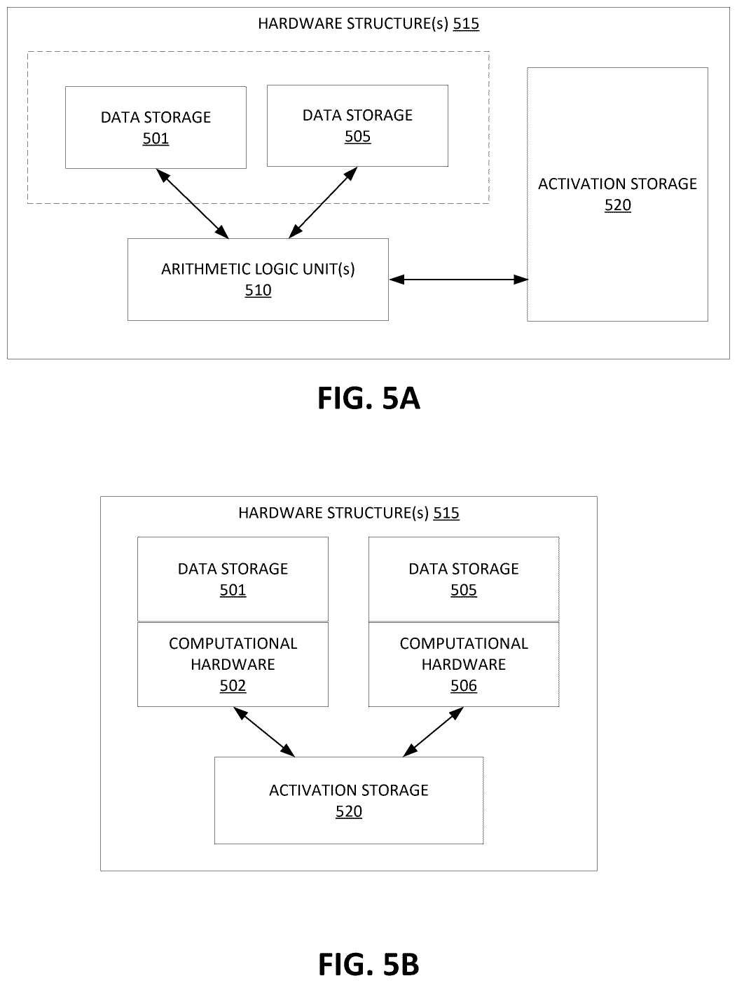

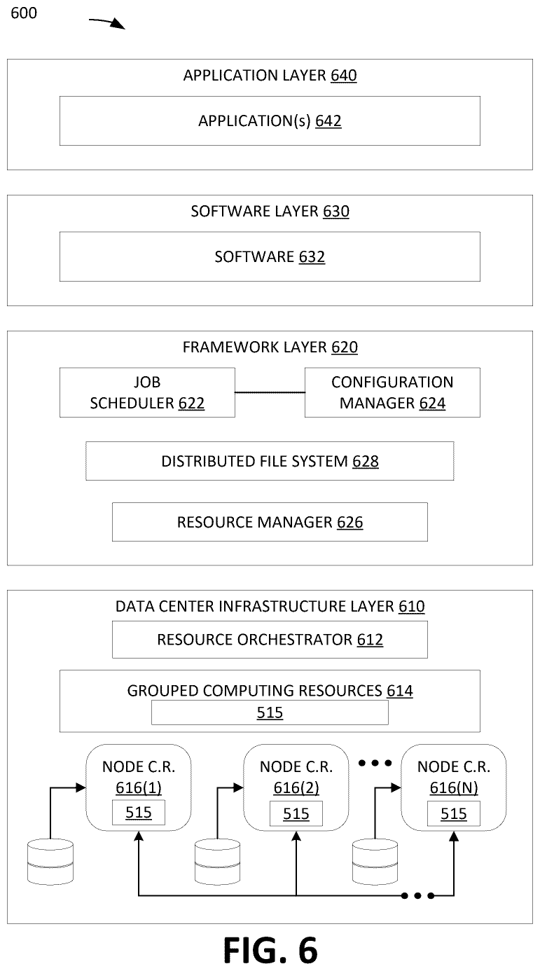

FIG. 5A illustrates inference and/or training logic 515 used to perform inferencing and/or training operations associated with one or more embodiments, such as with regards to an artificial intelligence (AI) model that generates animation data from audio data. Details regarding inference and/or training logic 515 are provided below in conjunction with FIGS. 5A and/or 5B.

In at least one embodiment, inference and/or training logic 515 may include, without limitation, code and/or data storage 501 to store forward and/or output weight and/or input/output data, and/or other parameters to configure neurons or layers of a neural network trained and/or used for inferencing in aspects of one or more embodiments. In at least one embodiment, training logic 515 may include, or be coupled to code and/or data storage 501 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 501 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 501 may be included with other on-chip or off-chip data storage, including a processor's L1, L2, or L3 cache or system memory.

In at least one embodiment, any portion of code and/or data storage 501 may be internal or external to one or more processors or other hardware logic devices or circuits. In at least one embodiment, code and/or code and/or data storage 501 may be cache memory, dynamic randomly addressable memory (“DRAM”), static randomly addressable memory (“SRAM”), non-volatile memory (e.g., Flash memory), or other storage. In at least one embodiment, choice of whether code and/or code and/or data storage 501 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 may include, without limitation, a code and/or data storage 505 to store backward and/or output weight and/or input/output data corresponding to neurons or layers of a neural network trained and/or used for inferencing in aspects of one or more embodiments. In at least one embodiment, code and/or data storage 505 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 515 may include, or be coupled to code and/or data storage 505 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 505 may be included with other on-chip or off-chip data storage, including a processor's L1, L2, or L3 cache or system memory. In at least one embodiment, any portion of code and/or data storage 505 may be internal or external to on one or more processors or other hardware logic devices or circuits. In at least one embodiment, code and/or data storage 505 may be cache memory, DRAM, SRAM, non-volatile memory (e.g., Flash memory), or other storage. In at least one embodiment, choice of whether code and/or data storage 505 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 501 and code and/or data storage 505 may be separate storage structures. In at least one embodiment, code and/or data storage 501 and code and/or data storage 505 may be same storage structure. In at least one embodiment, code and/or data storage 501 and code and/or data storage 505 may be partially same storage structure and partially separate storage structures. In at least one embodiment, any portion of code and/or data storage 501 and code and/or data storage 505 may be included with other on-chip or off-chip data storage, including a processor's L1, L2, or L3 cache or system memory.

In at least one embodiment, inference and/or training logic 515 may include, without limitation, one or more arithmetic logic unit(s) (“ALU(s)”) 510, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 520 that are functions of input/output and/or weight parameter data stored in code and/or data storage 501 and/or code and/or data storage 505. In at least one embodiment, activations stored in activation storage 520 are generated according to linear algebraic and or matrix-based mathematics performed by ALU(s) 510 in response to performing instructions or other code, wherein weight values stored in code and/or data storage 505 and/or code and/or data storage 501 are used as operands along with other values, such as bias values, gradient information, momentum values, or other parameters or hyperparameters, any or all of which may be stored in code and/or data storage 505 or code and/or data storage 501 or another storage on or off-chip.

In at least one embodiment, ALU(s) 510 are included within one or more processors or other hardware logic devices or circuits, whereas in another embodiment, ALU(s) 510 may be external to a processor or other hardware logic device or circuit that uses them (e.g., a co-processor). In at least one embodiment, ALUs 510 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 501, code and/or data storage 505, and activation storage 520 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 520 may be cache memory, DRAM, SRAM, non-volatile memory (e.g., Flash memory), or other storage. In at least one embodiment, activation storage 520 may be completely or partially within or external to one or more processors or other logical circuits. In at least one embodiment, choice of whether activation storage 520 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 515 illustrated in FIG. 5A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5A may be used in conjunction with central processing unit (“CPU”) hardware, graphics processing unit (“GPU”) hardware or other hardware, such as data processing unit (“DPU”) hardware, or field programmable gate arrays (“FPGAs”).

FIG. 5B illustrates inference and/or training logic 515, according to at least one or more embodiments. In at least one embodiment, inference and/or training logic 515 may include, without limitation, hardware logic in which computational resources are dedicated or otherwise exclusively used in conjunction with weight values or other information corresponding to one or more layers of neurons within a neural network. In at least one embodiment, inference and/or training logic 515 illustrated in FIG. 5B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5B may be used in conjunction with central processing unit (CPU) hardware, graphics processing unit (GPU) hardware or other hardware, such as data processing unit (“DPU”) hardware, or field programmable gate arrays (FPGAs). In at least one embodiment, inference and/or training logic 515 includes, without limitation, code and/or data storage 501 and code and/or data storage 505, which may be used to store code (e.g., graph code), weight values and/or other information, including bias values, gradient information, momentum values, and/or other parameter or hyperparameter information. In at least one embodiment illustrated in FIG. 5B, each of code and/or data storage 501 and code and/or data storage 505 is associated with a dedicated computational resource, such as computational hardware 502 and computational hardware 506, respectively. In at least one embodiment, each of computational hardware 502 and computational hardware 506 comprises one or more ALUs that perform mathematical functions, such as linear algebraic functions, only on information stored in code and/or data storage 501 and code and/or data storage 505, respectively, result of which is stored in activation storage 520.

In at least one embodiment, each of code and/or data storage 501 and 505 and corresponding computational hardware 502 and 506, respectively, correspond to different layers of a neural network, such that resulting activation from one “storage/computational pair 501/502” of code and/or data storage 501 and computational hardware 502 is provided as an input to “storage/computational pair 505/506” of code and/or data storage 505 and computational hardware 506, in order to mirror conceptual organization of a neural network. In at least one embodiment, each of storage/computational pairs 501/502 and 505/506 may correspond to more than one neural network layer. In at least one embodiment, additional storage/computation pairs (not shown) subsequent to or in parallel with storage computation pairs 501/502 and 505/506 may be included in inference and/or training logic 515.

### Data Center

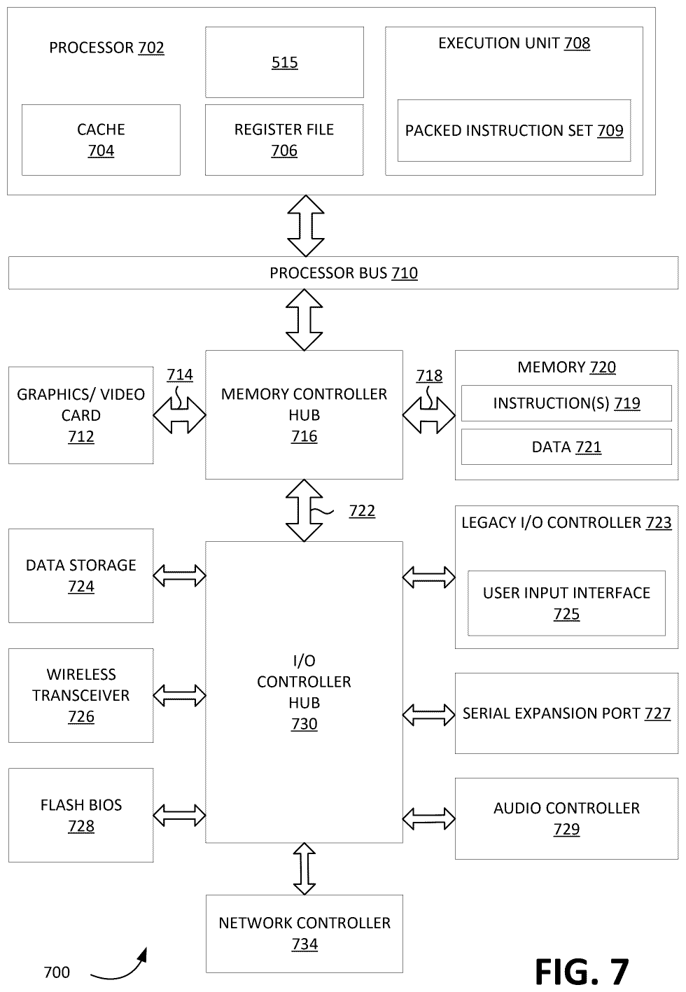

FIG. 6 illustrates an example data center 600, in which at least one embodiment may be used. For example, the data center 600 may house server device 160, data store 150 and/or computing device 102 of FIG. 1 in embodiments. In at least one embodiment, data center 600 includes a data center infrastructure layer 610, a framework layer 620, a software layer 630, and an application layer 640.

In at least one embodiment, as shown in FIG. 6, data center infrastructure layer 610 may include a resource orchestrator 612, grouped computing resources 614, and node computing resources (“node C.R.s”) 616(1)-1016(N), where “N” represents any whole, positive integer. In at least one embodiment, node C.R.s 616(1)-1016(N) may include, but are not limited to, any number of central processing units (“CPUs”) or other processors (including accelerators, field programmable gate arrays (FPGAs), data processing units, graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 616(1)-1016(N) may be a server having one or more of above-mentioned computing resources.

In at least one embodiment, grouped computing resources 614 may include separate groupings of node C.R.s housed within one or more racks (not shown), or many racks housed in data centers at various geographical locations (also not shown). Separate groupings of node C.R.s within grouped computing resources 614 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 612 may configure or otherwise control one or more node C.R.s 616(1)-1016(N) and/or grouped computing resources 614. In at least one embodiment, resource orchestrator 612 may include a software design infrastructure (“SDI”) management entity for data center 600. In at least one embodiment, resource orchestrator may include hardware, software or some combination thereof.

In at least one embodiment, as shown in FIG. 6, framework layer 620 includes a job scheduler 622, a configuration manager 624, a resource manager 626 and a distributed file system 628. In at least one embodiment, framework layer 620 may include a framework to support software 632 of software layer 630 and/or one or more application(s) 642 of application layer 640. In at least one embodiment, software 632 or application(s) 642 may respectively include web-based service software or applications, such as those provided by Amazon Web Services, Google Cloud and Microsoft Azure. In at least one embodiment, framework layer 620 may be, but is not limited to, a type of free and open-source software web application framework such as Apache Spark™ (hereinafter “Spark”) that may utilize distributed file system 628 for large-scale data processing (e.g., “big data”). In at least one embodiment, job scheduler 622 may include a Spark driver to facilitate scheduling of workloads supported by various layers of data center 600. In at least one embodiment, configuration manager 624 may be capable of configuring different layers such as software layer 630 and framework layer 620 including Spark and distributed file system 628 for supporting large-scale data processing. In at least one embodiment, resource manager 626 may be capable of managing clustered or grouped computing resources mapped to or allocated for support of distributed file system 628 and job scheduler 622. In at least one embodiment, clustered or grouped computing resources may include grouped computing resource 614 at data center infrastructure layer 610. In at least one embodiment, resource manager 626 may coordinate with resource orchestrator 612 to manage these mapped or allocated computing resources.

In at least one embodiment, software 632 included in software layer 630 may include software used by at least portions of node C.R.s 616(1)-1016(N), grouped computing resources 614, and/or distributed file system 628 of framework layer 620. The one or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-1016(N), grouped computing resources 614, and/or distributed file system 628 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 624, resource manager 626, and resource orchestrator 612 may implement any number and type of self-modifying actions based on any amount and type of data acquired in any technically feasible fashion. In at least one embodiment, self-modifying actions may relieve a data center operator of data center 600 from making possibly bad configuration decisions and possibly avoiding underutilized and/or poor performing portions of a data center.

In at least one embodiment, data center 600 may include tools, services, software, or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 600. In at least one embodiment, trained machine learning models corresponding to one or more neural networks may be used to infer or predict information using resources described above with respect to data center 600 by using weight parameters calculated through one or more training techniques described herein.

In at least one embodiment, data center may use CPUs, application-specific integrated circuits (ASICs), GPUs, DPUs FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 515 are used to perform inferencing and/or training operations associated with one or more embodiments. Details regarding inference and/or training logic 515 are provided below in conjunction with FIGS. 5A and/or 5B. In at least one embodiment, inference and/or training logic 515 may be used in system FIG. 6 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

### Computer Systems

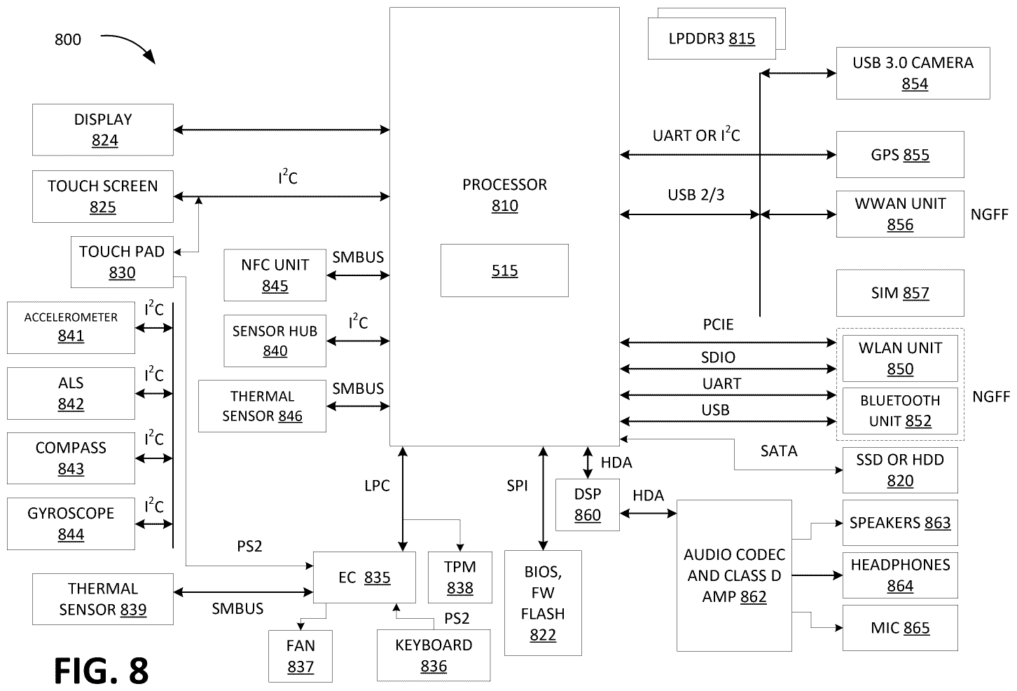

FIG. 7 is a block diagram illustrating an exemplary computer system 700, which may be a system with interconnected devices and components, a system-on-a-chip (SOC) or some combination thereof 700 formed with a processor that may include execution units to execute an instruction, according to at least one embodiment. In some embodiments, the computer system 700 can correspond to server device 160 and/or computing device 102 of FIG. 1. In at least one embodiment, computer system 700 may include, without limitation, a component, such as a processor 702 to employ execution units including logic to perform algorithms for process data, in accordance with present disclosure, such as in embodiment described herein. For example, processor 702 can be configured to execute instructions for implementing streaming and playback of synchronized audio and animation data. In at least one embodiment, computer system 700 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 700 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, edge devices, Internet-of-Things (“IoT”) devices, or any other system that may perform one or more instructions in accordance with at least one embodiment.

In at least one embodiment, computer system 700 may include, without limitation, processor 702 that may include, without limitation, one or more execution units 708 to perform machine learning model training and/or inferencing according to techniques described herein. In at least one embodiment, computer system 700 is a single processor desktop or server system, but in another embodiment computer system 700 may be a multiprocessor system. In at least one embodiment, processor 702 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 702 may be coupled to a processor bus 710 that may transmit data signals between processor 702 and other components in computer system 700.

In at least one embodiment, processor 702 may include, without limitation, a Level 1 (“L1”) internal cache memory (“cache”) 704. In at least one embodiment, processor 702 may have a single internal cache or multiple levels of internal cache. In at least one embodiment, cache memory may reside external to processor 702. Other embodiments may also include a combination of both internal and external caches depending on particular implementation and needs. In at least one embodiment, register file 706 may store different types of data in various registers including, without limitation, integer registers, floating point registers, status registers, and instruction pointer register.

In at least one embodiment, execution unit 708, including, without limitation, logic to perform integer and floating point operations, also resides in processor 702. In at least one embodiment, processor 702 may also include a microcode (“ucode”) read only memory (“ROM”) that stores microcode for certain macro instructions. In at least one embodiment, execution unit 708 may include logic to handle a packed instruction set 709. In at least one embodiment, by including packed instruction set 709 in an instruction set of a general-purpose processor 702, along with associated circuitry to execute instructions, operations used by many multimedia applications may be performed using packed data in a general-purpose processor 702. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 708 may also be used in microcontrollers, embedded processors, graphics devices, DSPs, and other types of logic circuits. In at least one embodiment, computer system 700 may include, without limitation, a memory 720. In at least one embodiment, memory 720 may be implemented as a Dynamic Random Access Memory (“DRAM”) device, a Static Random Access Memory (“SRAM”) device, flash memory device, or other memory device. In at least one embodiment, memory 720 may store instruction(s) 719 and/or data 721 represented by data signals that may be executed by processor 702.

In at least one embodiment, system logic chip may be coupled to processor bus 710 and memory 720. In at least one embodiment, system logic chip may include, without limitation, a memory controller hub (“MCH”) 716, and processor 702 may communicate with MCH 716 via processor bus 710. In at least one embodiment, MCH 716 may provide a high bandwidth memory path 718 to memory 720 for instruction and data storage and for storage of graphics commands, data and textures. In at least one embodiment, MCH 716 may direct data signals between processor 702, memory 720, and other components in computer system 700 and to bridge data signals between processor bus 710, memory 720, and a system I/O 722. In at least one embodiment, system logic chip may provide a graphics port for coupling to a graphics controller. In at least one embodiment, MCH 716 may be coupled to memory 720 through a high bandwidth memory path 718 and graphics/video card 712 may be coupled to MCH 716 through an Accelerated Graphics Port (“AGP”) interconnect 714.

In at least one embodiment, computer system 700 may use system I/O 722 that is a proprietary hub interface bus to couple MCH 716 to I/O controller hub (“ICH”) 730. In at least one embodiment, ICH 730 may provide direct connections to some I/O devices via a local I/O bus. In at least one embodiment, local I/O bus may include, without limitation, a high-speed I/O bus for connecting peripherals to memory 720, chipset, and processor 702. Examples may include, without limitation, an audio controller 729, a firmware hub (“flash BIOS”) 728, a wireless transceiver 726, a data storage 724, a legacy I/O controller 723 containing user input and keyboard interfaces 725, a serial expansion port 727, such as Universal Serial Bus (“USB”), and a network controller 734, which may include in some embodiments, a data processing unit. Data storage 724 may comprise a hard disk drive, a floppy disk drive, a CD-ROM device, a flash memory device, or other mass storage device.

In at least one embodiment, FIG. 7 illustrates a system, which includes interconnected hardware devices or “chips”, whereas in other embodiments, FIG. 7 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 700 are interconnected using compute express link (CXL) interconnects.

Inference and/or training logic 515 are used to perform inferencing and/or training operations associated with one or more embodiments. Details regarding inference and/or training logic 515 are provided below in conjunction with FIGS. 5A and/or B. In at least one embodiment, inference and/or training logic 515 may be used in system FIG. 7 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

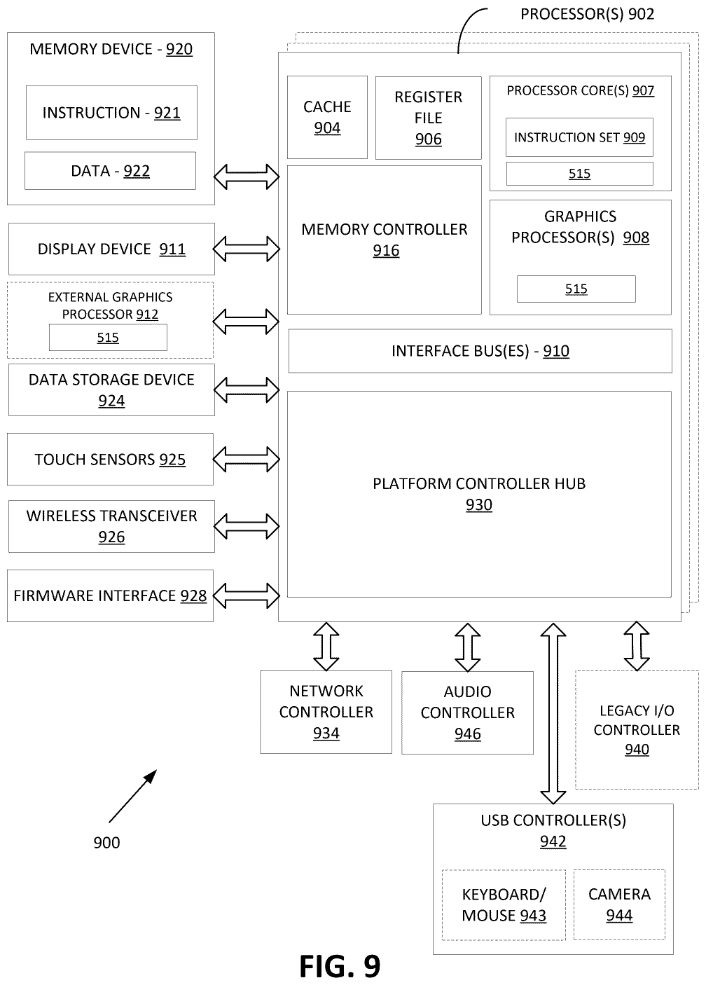

FIG. 8 is a block diagram illustrating an electronic device 800 for utilizing a processor 810, according to at least one embodiment. In at least one embodiment, electronic device 800 may be, for example and without limitation, a notebook, a tower server, a rack server, a blade server, a laptop, a desktop, a tablet, a mobile device, a phone, an embedded computer, an edge device, an IoT device, or any other suitable electronic device. For example, electronic device 800 can correspond to computing device 102 and/or server device 160 of FIG. 1.

In at least one embodiment, system 800 may include, without limitation, processor 810 communicatively coupled to any suitable number or kind of components, peripherals, modules, or devices. In at least one embodiment, processor 810 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 8 illustrates a system, which includes interconnected hardware devices or “chips”, whereas in other embodiments, FIG. 8 may illustrate an exemplary System on a Chip (“SoC”). In at least one embodiment, devices illustrated in FIG. 8 may be interconnected with proprietary interconnects, standardized interconnects (e.g., PCIe) or some combination thereof. In at least one embodiment, one or more components of FIG. 8 are interconnected using compute express link (CXL) interconnects.

In at least one embodiment, FIG. 8 may include a display 824, a touch screen 825, a touch pad 830, a Near Field Communications unit (“NFC”) 845, a sensor hub 840, a thermal sensor 846, an Express Chipset (“EC”) 835, a Trusted Platform Module (“TPM”) 838, BIOS/firmware/flash memory (“BIOS, FW Flash”) 822, a DS P860, a drive 820 such as a Solid State Disk (“SSD”) or a Hard Disk Drive (“HDD”), a wireless local area network unit (“WLAN”) 850, a Bluetooth unit 852, a Wireless Wide Area Network unit (“WWAN”) 856, a Global Positioning System (GPS) 855, a camera (“USB 3.0 camera”) 854 such as a USB 3.0 camera, and/or a Low Power Double Data Rate (“LPDDR”) memory unit (“LPDDR3”) 815 implemented in, for example, LPDDR3 standard. These components may each be implemented in any suitable manner.

In at least one embodiment, other components may be communicatively coupled to processor 810 through components discussed above. In at least one embodiment, an accelerometer 841, Ambient Light Sensor (“ALS”) 842, compass 843, and a gyroscope 844 may be communicatively coupled to sensor hub 840. In at least one embodiment, thermal sensor 839, a fan 837, a keyboard 836, and a touch pad 830 may be communicatively coupled to EC 835. In at least one embodiment, speaker 863, headphones 864, and microphone (“mic”) 865 may be communicatively coupled to an audio unit (“audio codec and class d amp”) 862, which may in turn be communicatively coupled to DSP 860. In at least one embodiment, audio unit 864 may include, for example and without limitation, an audio coder/decoder (“codec”) and a class D amplifier. In at least one embodiment, SIM card (“SIM”) 857 may be communicatively coupled to WWAN unit 856. In at least one embodiment, components such as WLAN unit 850 and Bluetooth unit 852, as well as WWAN unit 856 may be implemented in a Next Generation Form Factor (“NGFF”).

Inference and/or training logic 515 are used to perform inferencing and/or training operations associated with one or more embodiments. Details regarding inference and/or training logic 515 are provided below in conjunction with FIGS. 5A and/or 5B. In at least one embodiment, inference and/or training logic 515 may be used in system FIG. 8 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

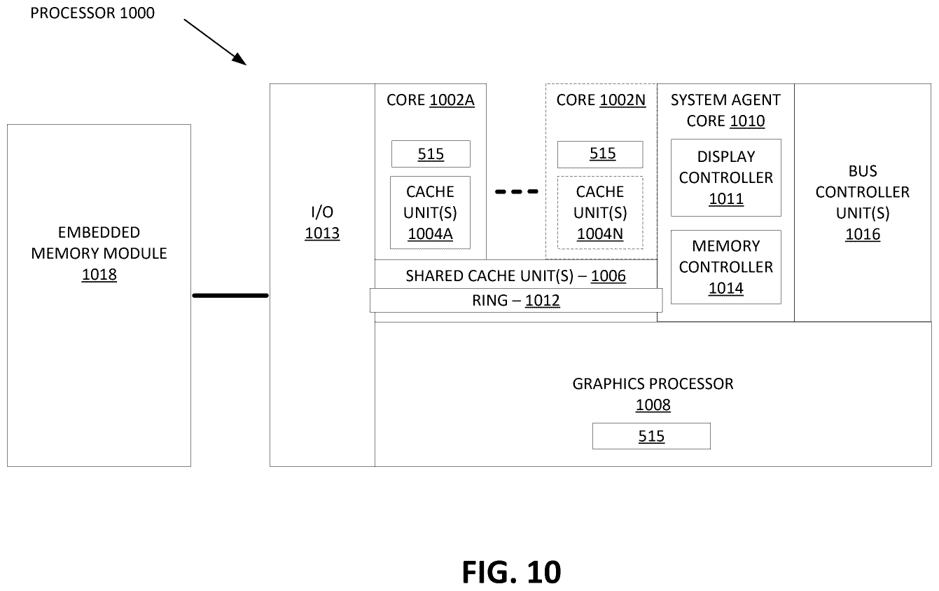

FIG. 9 is a block diagram of a processing system 900, according to at least one embodiment. For example, processing system 900 can correspond to server device 160, data store 150, and/or computing device 102 of FIG. 1 in embodiments. In at least one embodiment, system 900 includes one or more processors 902 and one or more graphics processors 908, and may be a single processor desktop system, a multiprocessor workstation system, or a server system having a large number of processors 902 or processor cores 907. In at least one embodiment, system 900 is a processing platform incorporated within a system-on-a-chip (SoC) integrated circuit for use in mobile, handheld, edge, or embedded devices.

In at least one embodiment, system 900 may include, or be incorporated within a server-based gaming platform, a game console, including a game and media console, a mobile gaming console, a handheld game console, or an online game console. In at least one embodiment, system 900 is a mobile phone, smart phone, tablet computing device or mobile Internet device. In at least one embodiment, processing system 900 may also include, couple with, or be integrated within a wearable device, such as a smart watch wearable device, smart eyewear device, augmented reality device, or virtual reality device. In at least one embodiment, processing system 900 is a television or set top box device having one or more processors 902 and a graphical interface generated by one or more graphics processors 908.

In at least one embodiment, one or more processors 902 each include one or more processor cores 907 to process instructions which, when executed, perform operations for system and user software. In at least one embodiment, each of one or more processor cores 907 is configured to process a specific instruction set 909. In at least one embodiment, instruction set 909 may facilitate Complex Instruction Set Computing (CISC), Reduced Instruction Set Computing (RISC), or computing via a Very Long Instruction Word (VLIW). In at least one embodiment, processor cores 907 may each process a different instruction set 909, which may include instructions to facilitate emulation of other instruction sets. In at least one embodiment, processor core 907 may also include other processing devices, such a Digital Signal Processor (DSP).

In at least one embodiment, processor 902 includes cache memory 904. In at least one embodiment, processor 902 may have a single internal cache or multiple levels of internal cache. In at least one embodiment, cache memory is shared among various components of processor 902. In at least one embodiment, processor 902 also uses an external cache (e.g., a Level-3 (L3) cache or Last Level Cache (LLC)) (not shown), which may be shared among processor cores 907 using known cache coherency techniques. In at least one embodiment, register file 906 is additionally included in processor 902 which may include different types of registers for storing different types of data (e.g., integer registers, floating point registers, status registers, and an instruction pointer register). In at least one embodiment, register file 906 may include general-purpose registers or other registers.

In at least one embodiment, one or more processor(s) 902 are coupled with one or more interface bus(es) 910 to transmit communication signals such as address, data, or control signals between processor 902 and other components in system 900. In at least one embodiment, interface bus 910, in one embodiment, may be a processor bus, such as a version of a Direct Media Interface (DMI) bus. In at least one embodiment, interface 910 is not limited to a DMI bus, and may include one or more Peripheral Component Interconnect buses (e.g., PCI, PCI Express), memory busses, or other types of interface busses. In at least one embodiment processor(s) 902 include an integrated memory controller 916 and a platform controller hub 930. In at least one embodiment, memory controller 916 facilitates communication between a memory device and other components of system 900, while platform controller hub (PCH) 930 provides connections to I/O devices via a local I/O bus.

In at least one embodiment, memory device 920 may be a dynamic random access memory (DRAM) device, a static random access memory (SRAM) device, flash memory device, phase-change memory device, or some other memory device having suitable performance to serve as process memory. In at least one embodiment memory device 920 may operate as system memory for system 900, to store data 922 and instructions 921 for use when one or more processors 902 executes an application or process. In at least one embodiment, memory controller 916 also couples with an optional external graphics processor 912, which may communicate with one or more graphics processors 908 in processors 902 to perform graphics and media operations. In at least one embodiment, a display device 911 may connect to processor(s) 902. In at least one embodiment display device 911 may include one or more of an internal display device, as in a mobile electronic device or a laptop device or an external display device attached via a display interface (e.g., DisplayPort, etc.). In at least one embodiment, display device 911 may include a head mounted display (HMD) such as a stereoscopic display device for use in virtual reality (VR) applications or augmented reality (AR) applications.

In at least one embodiment, platform controller hub 930 enables peripherals to connect to memory device 920 and processor 902 via a high-speed I/O bus. In at least one embodiment, I/O peripherals include, but are not limited to, an audio controller 946, a network controller 934, a firmware interface 928, a wireless transceiver 926, touch sensors 925, a data storage device 924 (e.g., hard disk drive, flash memory, etc.). In at least one embodiment, data storage device 924 may connect via a storage interface (e.g., SATA) or via a peripheral bus, such as a Peripheral Component Interconnect bus (e.g., PCI, PCI Express). In at least one embodiment, touch sensors 925 may include touch screen sensors, pressure sensors, or fingerprint sensors. In at least one embodiment, wireless transceiver 926 may be a Wi-Fi transceiver, a Bluetooth transceiver, or a mobile network transceiver such as a 3G, 4G, or Long Term Evolution (LTE) transceiver. In at least one embodiment, firmware interface 928 enables communication with system firmware, and may be, for example, a unified extensible firmware interface (UEFI). In at least one embodiment, network controller 934 may enable a network connection to a wired network. In at least one embodiment, a high-performance network controller (not shown) couples with interface bus 910. In at least one embodiment, audio controller 946 is a multi-channel high definition audio controller. In at least one embodiment, system 900 includes an optional legacy I/O controller 940 for coupling legacy (e.g., Personal System 2 (PS/2)) devices to system. In at least one embodiment, platform controller hub 930 may also connect to one or more Universal Serial Bus (USB) controllers 942 connect input devices, such as keyboard and mouse 943 combinations, a camera 944, or other USB input devices.

In at least one embodiment, an instance of memory controller 916 and platform controller hub 930 may be integrated into a discreet external graphics processor, such as external graphics processor 912. In at least one embodiment, platform controller hub 930 and/or memory controller 916 may be external to one or more processor(s) 902. For example, in at least one embodiment, system 900 may include an external memory controller 916 and platform controller hub 930, which may be configured as a memory controller hub and peripheral controller hub within a system chipset that is in communication with processor(s) 902.

Inference and/or training logic 515 are used to perform inferencing and/or training operations associated with one or more embodiments. Details regarding inference and/or training logic 515 are provided below in conjunction with FIGS. 5A and/or 5B. In at least one embodiment portions or all of inference and/or training logic 515 may be incorporated into graphics processor 900. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIG. 5A or 5B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components may be used to generate synthetic data imitating failure cases in a network training process, which may help to improve performance of the network while limiting the amount of synthetic data to avoid overfitting.

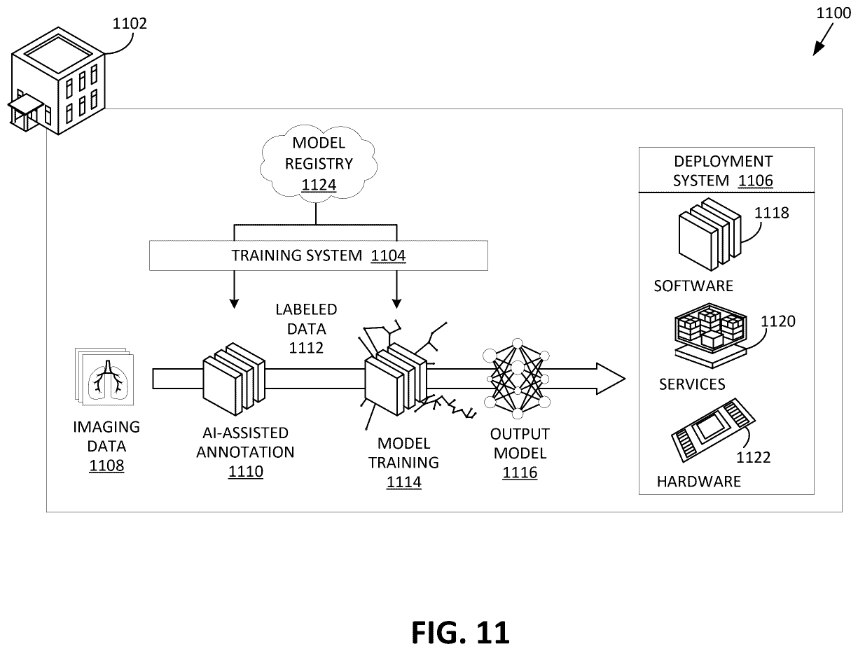

FIG. 10 is a block diagram of a processor 1000 having one or more processor cores 1002A-1002N, an integrated memory controller 1014, and an integrated graphics processor 1008, according to at least one embodiment. For example, processor 1000 may be included in, or otherwise accessed by, server device 160, data store 150, and/or computing device 102 of FIG. 1, in embodiments. In at least one embodiment, processor 1000 may include additional cores up to and including additional core 1002N represented by dashed lined boxes. In at least one embodiment, each of processor cores 1002A-1002N includes one or more internal cache units 1004A-1004N. In at least one embodiment, each processor core also has access to one or more shared cached units 1006.

In at least one embodiment, internal cache units 1004A-1004N and shared cache units 1006 represent a cache memory hierarchy within processor 1000. In at least one embodiment, cache memory units 1004A-1004N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache units 1006 and 1004A-1004N.

In at least one embodiment, processor 1000 may also include a set of one or more bus controller units 1016 and a system agent core 1010. In at least one embodiment, one or more bus controller units 1016 manage a set of peripheral buses, such as one or more PCI or PCI express busses. In at least one embodiment, system agent core 1010 provides management functionality for various processor components. In at least one embodiment, system agent core 1010 includes one or more integrated memory controllers 1014 to manage access to various external memory devices (not shown).

In at least one embodiment, one or more of processor cores 1002A-1002N include support for simultaneous multi-threading. In at least one embodiment, system agent core 1010 includes components for coordinating and operating cores 1002A-1002N during multi-threaded processing. In at least one embodiment, system agent core 1010 may additionally include a power control unit (PCU), which includes logic and components to regulate one or more power states of processor cores 1002A-1002N and graphics processor 1008.

In at least one embodiment, processor 1000 additionally includes graphics processor 1008 to execute graphics processing operations. In at least one embodiment, graphics processor 1008 couples with shared cache units 1006, and system agent core 1010, including one or more integrated memory controllers 1014. In at least one embodiment, system agent core 1010 also includes a display controller 1011 to drive graphics processor output to one or more coupled displays. In at least one embodiment, display controller 1011 may also be a separate module coupled with graphics processor 1008 via at least one interconnect, or may be integrated within graphics processor 1008.

In at least one embodiment, a ring based interconnect unit 1012 is used to couple internal components of processor 1000. In at least one embodiment, an alternative interconnect unit may be used, such as a point-to-point interconnect, a switched interconnect, or other techniques. In at least one embodiment, graphics processor 1008 couples with ring interconnect 1012 via an I/O link 1013.

In at least one embodiment, I/O link 1013 represents at least one of multiple varieties of I/O interconnects, including an on package I/O interconnect which facilitates communication between various processor components and a high-performance embedded memory module 1018, such as an eDRAM module. In at least one embodiment, each of processor cores 1002A-1002N and graphics processor 1008 use embedded memory modules 1018 as a shared Last Level Cache.

In at least one embodiment, processor cores 1002A-1002N are homogenous cores executing a common instruction set architecture. In at least one embodiment, processor cores 1002A-1002N are heterogeneous in terms of instruction set architecture (ISA), where one or more of processor cores 1002A-1002N execute a common instruction set, while one or more other cores of processor cores 1002A-1002N executes a subset of a common instruction set or a different instruction set. In at least one embodiment, processor cores 1002A-1002N are heterogeneous in terms of microarchitecture, where one or more cores having a relatively higher power consumption couple with one or more power cores having a lower power consumption. In at least one embodiment, processor 1000 may be implemented on one or more chips or as an SoC integrated circuit.

Inference and/or training logic 515 are used to perform inferencing and/or training operations associated with one or more embodiments. Details regarding inference and/or training logic 515 are provided below in conjunction with FIGS. 5A and/or 5B. In at least one embodiment portions or all of inference and/or training logic 515 may be incorporated into processor 1000. For example, in at least one embodiment, training and/or inferencing techniques described herein may use one or more of ALUs embodied in graphics processor 1008, graphics core(s) 1002A-1002N, or other components in FIG. 10. Moreover, in at least one embodiment, inferencing and/or training operations described herein may be done using logic other than logic illustrated in FIG. 5A or 5B. In at least one embodiment, weight parameters may be stored in on-chip or off-chip memory and/or registers (shown or not shown) that configure ALUs of graphics processor 1000 to perform one or more machine learning algorithms, neural network architectures, use cases, or training techniques described herein.

Such components may be used to generate synthetic data imitating failure cases in a network training process, which may help to improve performance of the network while limiting the amount of synthetic data to avoid overfitting.

### Virtualized Computing Platform

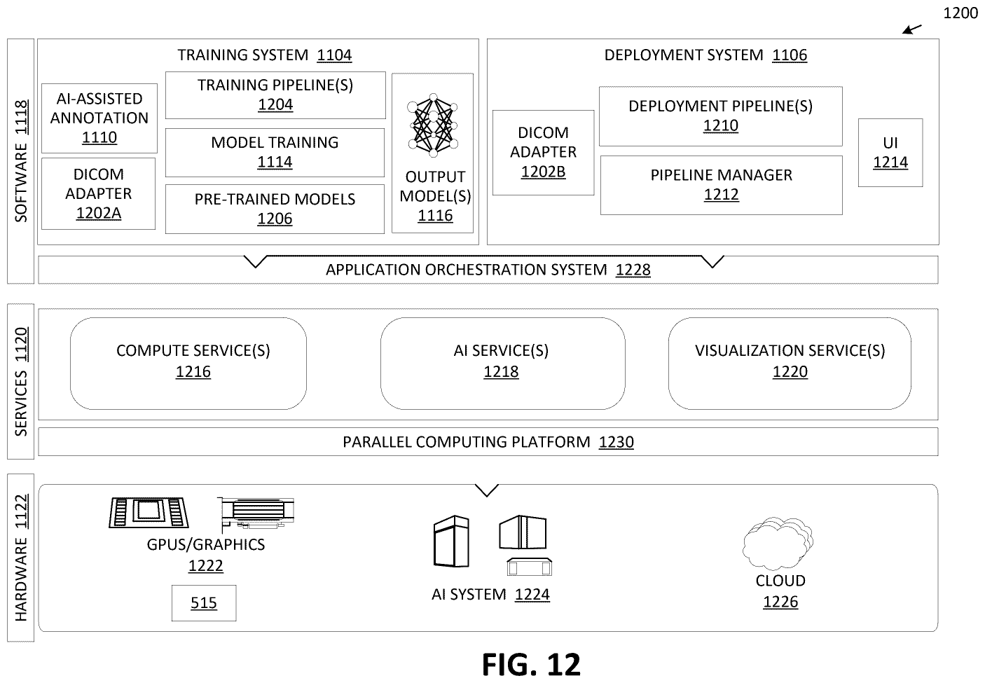

FIG. 11 is an example data flow diagram for a process 1100 of generating and deploying an image processing and inferencing pipeline, in accordance with at least one embodiment, such as with regards to the generation of animation data as described herein. In at least one embodiment, process 1100 may be deployed for use with imaging devices, processing devices, and/or other device types at one or more facilities 1102. Process 1100 may be executed within a training system 1104 and/or a deployment system 1106. In at least one embodiment, training system 1104 may be used to perform training, deployment, and implementation of machine learning models (e.g., neural networks, object detection algorithms, computer vision algorithms, etc.) for use in deployment system 1106. In at least one embodiment, deployment system 1106 may be configured to offload processing and compute resources among a distributed computing environment to reduce infrastructure requirements at facility 1102. In at least one embodiment, one or more applications in a pipeline may use or call upon services (e.g., inference, visualization, compute, AI, etc.) of deployment system 1106 during execution of applications.

In at least one embodiment, some of applications used in advanced processing and inferencing pipelines may use machine learning models or other AI to perform one or more processing steps. In at least one embodiment, machine learning models may be trained at facility 1102 using data 1108 (such as imaging data) generated at facility 1102 (and stored on one or more picture archiving and communication system (PACS) servers at facility 1102), may be trained using imaging or sequencing data 1108 from another facility(ies), or a combination thereof. In at least one embodiment, training system 1104 may be used to provide applications, services, and/or other resources for generating working, deployable machine learning models for deployment system 1106.

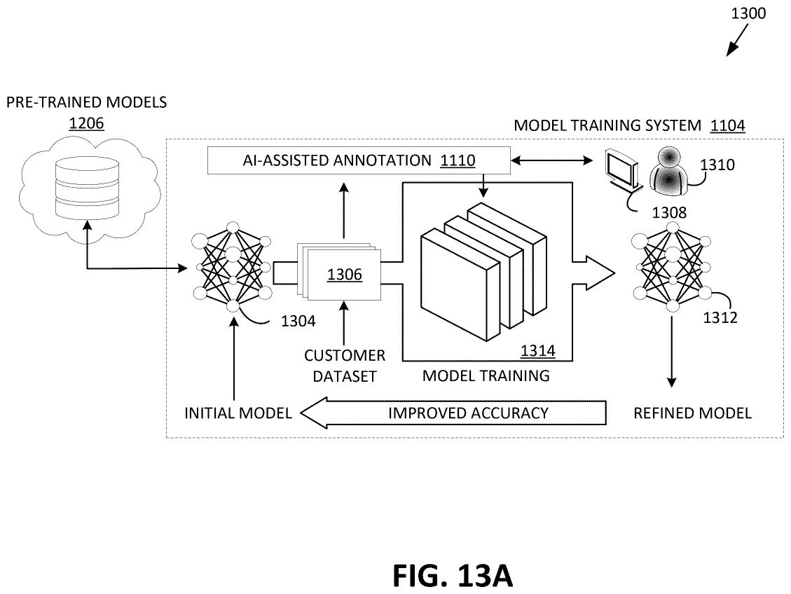

In at least one embodiment, model registry 1124 may be backed by object storage that may support versioning and object metadata. In at least one embodiment, object storage may be accessible through, for example, a cloud storage (e.g., cloud 1226 of FIG. 12) compatible application programming interface (API) from within a cloud platform. In at least one embodiment, machine learning models within model registry 1124 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training pipeline 1204 (FIG. 12) may include a scenario where facility 1102 is training their own machine learning model, or has an existing machine learning model that needs to be optimized or updated. In at least one embodiment, imaging data 1108 generated by imaging device(s), sequencing devices, and/or other device types may be received. In at least one embodiment, once imaging data 1108 is received, AI-assisted annotation 1110 may be used to aid in generating annotations corresponding to imaging data 1108 to be used as ground truth data for a machine learning model. In at least one embodiment, AI-assisted annotation 1110 may include one or more machine learning models (e.g., convolutional neural networks (CNNs)) that may be trained to generate annotations corresponding to certain types of imaging data 1108 (e.g., from certain devices). In at least one embodiment, AI-assisted annotations 1110 may then be used directly, or may be adjusted or fine-tuned using an annotation tool to generate ground truth data. In at least one embodiment, AI-assisted annotations 1110, labeled clinic data 1112, or a combination thereof may be used as ground truth data for training a machine learning model. In at least one embodiment, a trained machine learning model may be referred to as output model 1116, and may be used by deployment system 1106, as described herein.

In at least one embodiment, training pipeline 1204 (FIG. 12) may include a scenario where facility 1102 needs a machine learning model for use in performing one or more processing tasks for one or more applications in deployment system 1106, but facility 1102 may not currently have such a machine learning model (or may not have a model that is optimized, efficient, or effective for such purposes). In at least one embodiment, an existing machine learning model may be selected from a model registry 1124. In at least one embodiment, model registry 1124 may include machine learning models trained to perform a variety of different inference tasks on imaging data. In at least one embodiment, machine learning models in model registry 1124 may have been trained on imaging data from different facilities than facility 1102 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1124. In at least one embodiment, a machine learning model may then be retrained, or updated, at any number of other facilities, and a retrained or updated model may be made available in model registry 1124. In at least one embodiment, a machine learning model may then be selected from model registry 1124—and referred to as output model 1116—and may be used in deployment system 1106 to perform one or more processing tasks for one or more applications of a deployment system.

In at least one embodiment, training pipeline 1204 (FIG. 12), a scenario may include facility 1102 requiring a machine learning model for use in performing one or more processing tasks for one or more applications in deployment system 1106, but facility 1102 may not currently have such a machine learning model (or may not have a model that is optimized, efficient, or effective for such purposes). In at least one embodiment, a machine learning model selected from model registry 1124 may not be fine-tuned or optimized for imaging data 1108 generated at facility 1102 because of differences in populations, robustness of training data used to train a machine learning model, diversity in anomalies of training data, and/or other issues with training data. In at least one embodiment, AI-assisted annotation 1110 may be used to aid in generating annotations corresponding to imaging data 1108 to be used as ground truth data for retraining or updating a machine learning model. In at least one embodiment, labeled data 1112 may be used as ground truth data for training a machine learning model. In at least one embodiment, retraining or updating a machine learning model may be referred to as model training 1114. In at least one embodiment, model training 1114—e.g., AI-assisted annotations 1110, labeled clinic data 1112, or a combination thereof—may be used as ground truth data for retraining or updating a machine learning model. In at least one embodiment, a trained machine learning model may be referred to as output model 1116, and may be used by deployment system 1106, as described herein.

In at least one embodiment, deployment system 1106 may include software 1118, services 1120, hardware 1122, and/or other components, features, and functionality. In at least one embodiment, deployment system 1106 may include a software “stack,” such that software 1118 may be built on top of services 1120 and may use services 1120 to perform some or all of processing tasks, and services 1120 and software 1118 may be built on top of hardware 1122 and use hardware 1122 to execute processing, storage, and/or other compute tasks of deployment system 1106. In at least one embodiment, software 1118 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1108, in addition to containers that receive and configure imaging data for use by each container and/or for use by facility 1102 after processing through a pipeline (e.g., to convert outputs back to a usable data type). In at least one embodiment, a combination of containers within software 1118 (e.g., that make up a pipeline) may be referred to as a virtual instrument (as described in more detail herein), and a virtual instrument may leverage services 1120 and hardware 1122 to execute some or all processing tasks of applications instantiated in containers.

In at least one embodiment, a data processing pipeline may receive input data (e.g., imaging data 1108) in a specific format in response to an inference request (e.g., a request from a user of deployment system 1106). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 1116 of training system 1104.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1124 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1120 as a system (e.g., system 1200 of FIG. 12). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by system 1200 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., system 1200 of FIG. 12). In at least one embodiment, completed and validated applications or containers may be stored in a container registry and associated machine learning models may be stored in model registry 1124. In at least one embodiment, a requesting entity—who provides an inference or image processing request—may browse a container registry and/or model registry 1124 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1106 (e.g., a cloud) to perform processing of data processing pipeline. In at least one embodiment, processing by deployment system 1106 may include referencing selected elements (e.g., applications, containers, models, etc.) from a container registry and/or model registry 1124. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1120 may be leveraged. In at least one embodiment, services 1120 may include compute services, artificial intelligence (AI) services, visualization services, and/or other service types. In at least one embodiment, services 1120 may provide functionality that is common to one or more applications in software 1118, so functionality may be abstracted to a service that may be called upon or leveraged by applications. In at least one embodiment, functionality provided by services 1120 may run dynamically and more efficiently, while also scaling well by allowing applications to process data in parallel (e.g., using a parallel computing platform 1230 (FIG. 12)). In at least one embodiment, rather than each application that shares a same functionality offered by a service 1120 being required to have a respective instance of service 1120, service 1120 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects—such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where a service 1120 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1118 implementing advanced processing and inferencing pipeline that includes segmentation application and anomaly detection application may be streamlined because each application may call upon a same inference service to perform one or more inferencing tasks.

In at least one embodiment, hardware 1122 may include GPUs, CPUs, DPUs, graphics cards, an AI/deep learning system (e.g., an AI supercomputer, such as NVIDIA's DGX), a cloud platform, or a combination thereof. In at least one embodiment, different types of hardware 1122 may be used to provide efficient, purpose-built support for software 1118 and services 1120 in deployment system 1106. In at least one embodiment, use of GPU processing may be implemented for processing locally (e.g., at facility 1102), within an AI/deep learning system, in a cloud system, and/or in other processing components of deployment system 1106 to improve efficiency, accuracy, and efficacy of image processing and generation. In at least one embodiment, software 1118 and/or services 1120 may be optimized for GPU processing with respect to deep learning, machine learning, and/or high-performance computing, as non-limiting examples. In at least one embodiment, at least some of computing environment of deployment system 1106 and/or training system 1104 may be executed in a datacenter one or more supercomputers or high performance computing systems, with GPU optimized software (e.g., hardware and software combination of NVIDIA's DGX System). In at least one embodiment, hardware 1122 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform may further include DPU processing to transmit data received over a network and/or through a network controller or other network interface directly to (e.g., a memory of) one or more GPU(s). In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 12 is a system diagram for an example system 1200 for generating and deploying an imaging deployment pipeline, in accordance with at least one embodiment, such as with regards to the generation of animation data as described herein. In at least one embodiment, system 1200 may be used to implement process 1100 of FIG. 11 and/or other processes including advanced processing and inferencing pipelines. In at least one embodiment, system 1200 may include training system 1104 and deployment system 1106. In at least one embodiment, training system 1104 and deployment system 1106 may be implemented using software 1118, services 1120, and/or hardware 1122, as described herein.

In at least one embodiment, system 1200 (e.g., training system 1104 and/or deployment system 1106) may implemented in a cloud computing environment (e.g., using cloud 1226). In at least one embodiment, system 1200 may be implemented locally with respect to a healthcare services facility, or as a combination of both cloud and local computing resources. In at least one embodiment, access to APIs in cloud 1226 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1200, may be restricted to a set of public IPs that have been vetted or authorized for interaction.

In at least one embodiment, various components of system 1200 may communicate between and among one another using any of a variety of different network types, including but not limited to local area networks (LANs) and/or wide area networks (WANs) via wired and/or wireless communication protocols. In at least one embodiment, communication between facilities and components of system 1200 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1104 may execute training pipelines 1204, similar to those described herein with respect to FIG. 11. In at least one embodiment, where one or more machine learning models are to be used in deployment pipelines 1210 by deployment system 1106, training pipelines 1204 may be used to train or retrain one or more (e.g. pre-trained) models, and/or implement one or more of pre-trained models 1206 (e.g., without a need for retraining or updating). In at least one embodiment, as a result of training pipelines 1204, output model(s) 1116 may be generated. In at least one embodiment, training pipelines 1204 may include any number of processing steps, such as but not limited to imaging data (or other input data) conversion or adaption In at least one embodiment, for different machine learning models used by deployment system 1106, different training pipelines 1204 may be used. In at least one embodiment, training pipeline 1204 similar to a first example described with respect to FIG. 11 may be used for a first machine learning model, training pipeline 1204 similar to a second example described with respect to FIG. 11 may be used for a second machine learning model, and training pipeline 1204 similar to a third example described with respect to FIG. 11 may be used for a third machine learning model. In at least one embodiment, any combination of tasks within training system 1104 may be used depending on what is required for each respective machine learning model. In at least one embodiment, one or more of machine learning models may already be trained and ready for deployment so machine learning models may not undergo any processing by training system 1104, and may be implemented by deployment system 1106.

In at least one embodiment, output model(s) 1116 and/or pre-trained model(s) 1206 may include any types of machine learning models depending on implementation or embodiment. In at least one embodiment, and without limitation, machine learning models used by system 1200 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

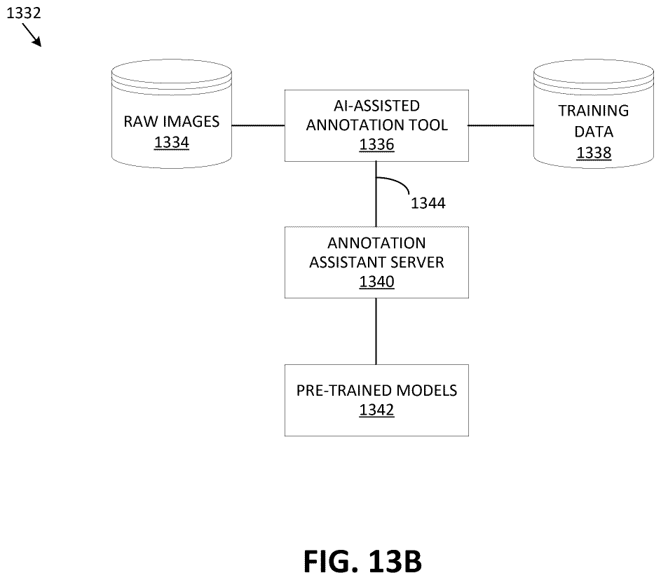

In at least one embodiment, training pipelines 1204 may include AI-assisted annotation, as described in more detail herein with respect to at least FIG. 13B. In at least one embodiment, labeled data 1112 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1108 (or other data type used by machine learning models), there may be corresponding ground truth data generated by training system 1104. In at least one embodiment, AI-assisted annotation may be performed as part of deployment pipelines 1210; either in addition to, or in lieu of AI-assisted annotation included in training pipelines 1204. In at least one embodiment, system 1200 may include a multi-layer platform that may include a software layer (e.g., software 1118) of diagnostic applications (or other application types) that may perform one or more medical imaging and diagnostic functions. In at least one embodiment, system 1200 may be communicatively coupled to (e.g., via encrypted links) PACS server networks of one or more facilities. In at least one embodiment, system 1200 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility 1102). In at least one embodiment, applications may then call or execute one or more services 1120 for performing compute, AI, or visualization tasks associated with respective applications, and software 1118 and/or services 1120 may leverage hardware 1122 to perform processing tasks in an effective and efficient manner.

In at least one embodiment, deployment system 1106 may execute deployment pipelines 1210. In at least one embodiment, deployment pipelines 1210 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline 1210 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline 1210 depending on information desired from data generated by a device. In at least one embodiment, where detections of anomalies are desired from an MRI machine, there may be a first deployment pipeline 1210, and where image enhancement is desired from output of an MRI machine, there may be a second deployment pipeline 1210.

In at least one embodiment, an image generation application may include a processing task that includes use of a machine learning model. In at least one embodiment, a user may desire to use their own machine learning model, or to select a machine learning model from model registry 1124. In at least one embodiment, a user may implement their own machine learning model or select a machine learning model for inclusion in an application for performing a processing task. In at least one embodiment, applications may be selectable and customizable, and by defining constructs of applications, deployment, and implementation of applications for a particular user are presented as a more seamless user experience. In at least one embodiment, by leveraging other features of system 1200—such as services 1120 and hardware 1122—deployment pipelines 1210 may be even more user friendly, provide for easier integration, and produce more accurate, efficient, and timely results.

In at least one embodiment, deployment system 1106 may include a user interface 1214 (e.g., a graphical user interface, a web interface, etc.) that may be used to select applications for inclusion in deployment pipeline(s) 1210, arrange applications, modify, or change applications or parameters or constructs thereof, use and interact with deployment pipeline(s) 1210 during set-up and/or deployment, and/or to otherwise interact with deployment system 1106. In at least one embodiment, although not illustrated with respect to training system 1104, user interface 1214 (or a different user interface) may be used for selecting models for use in deployment system 1106, for selecting models for training, or retraining, in training system 1104, and/or for otherwise interacting with training system 1104.

In at least one embodiment, pipeline manager 1212 may be used, in addition to an application orchestration system 1228, to manage interaction between applications or containers of deployment pipeline(s) 1210 and services 1120 and/or hardware 1122. In at least one embodiment, pipeline manager 1212 may be configured to facilitate interactions from application to application, from application to service 1120, and/or from application or service to hardware 1122. In at least one embodiment, although illustrated as included in software 1118, this is not intended to be limiting, and in some examples (e.g., as illustrated in FIG. 10) pipeline manager 1212 may be included in services 1120. In at least one embodiment, application orchestration system 1228 (e.g., Kubernetes, DOCKER, etc.) may include a container orchestration system that may group applications into containers as logical units for coordination, management, scaling, and deployment. In at least one embodiment, by associating applications from deployment pipeline(s) 1210 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1212 and application orchestration system 1228. In at least one embodiment, so long as an expected input and/or output of each container or application is known by a system (e.g., based on constructs of applications or containers), application orchestration system 1228 and/or pipeline manager 1212 may facilitate communication among and between, and sharing of resources among and between, each of applications or containers. In at least one embodiment, because one or more of applications or containers in deployment pipeline(s) 1210 may share same services and resources, application orchestration system 1228 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1228) may determine resource availability and distribution based on constraints imposed on a system (e.g., user constraints), such as quality of service (QOS), urgency of need for data outputs (e.g., to determine whether to execute real-time processing or delayed processing), etc.

In at least one embodiment, services 1120 leveraged by and shared by applications or containers in deployment system 1106 may include compute services 1216, AI services 1218, visualization services 1220, and/or other service types. In at least one embodiment, applications may call (e.g., execute) one or more of services 1120 to perform processing operations for an application. In at least one embodiment, compute services 1216 may be leveraged by applications to perform super-computing or other high-performance computing (HPC) tasks. In at least one embodiment, compute service(s) 1216 may be leveraged to perform parallel processing (e.g., using a parallel computing platform 1230) for processing data through one or more of applications and/or one or more tasks of a single application, substantially simultaneously. In at least one embodiment, parallel computing platform 1230 (e.g., NVIDIA's CUDA) may enable general purpose computing on GPUs (GPGPU) (e.g., GPUs 1222). In at least one embodiment, a software layer of parallel computing platform 1230 may provide access to virtual instruction sets and parallel computational elements of GPUs, for execution of compute kernels. In at least one embodiment, parallel computing platform 1230 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1230 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1218 may be leveraged to perform inferencing services for executing machine learning model(s) associated with applications (e.g., tasked with performing one or more processing tasks of an application). In at least one embodiment, AI services 1218 may leverage AI system 1224 to execute machine learning model(s) (e.g., neural networks, such as CNNs) for segmentation, reconstruction, object detection, feature detection, classification, and/or other inferencing tasks. In at least one embodiment, applications of deployment pipeline(s) 1210 may use one or more of output models 1116 from training system 1104 and/or other models of applications to perform inference on imaging data. In at least one embodiment, two or more examples of inferencing using application orchestration system 1228 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1228 may distribute resources (e.g., services 1120 and/or hardware 1122) based on priority paths for different inferencing tasks of AI services 1218.

In at least one embodiment, shared storage may be mounted to AI services 1218 within system 1200. In at least one embodiment, shared storage may operate as a cache (or other storage device type) and may be used to process inference requests from applications. In at least one embodiment, when an inference request is submitted, a request may be received by a set of API instances of deployment system 1106, and one or more instances may be selected (e.g., for best fit, for load balancing, etc.) to process a request. In at least one embodiment, to process a request, a request may be entered into a database, a machine learning model may be located from model registry 1124 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1212) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s) and/or DPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<11 min). In at least one embodiment, model execution times may be measured from requesting institution or entity and may include partner network traversal time, as well as execution on an inference service.

In at least one embodiment, transfer of requests between services 1120 and inference applications may be hidden behind a software development kit (SDK), and robust transport may be provided through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1226, and an inference service may perform inferencing on a GPU.

In at least one embodiment, visualization services 1220 may be leveraged to generate visualizations for viewing outputs of applications and/or deployment pipeline(s) 1210. In at least one embodiment, GPUs 1222 may be leveraged by visualization services 1220 to generate visualizations. In at least one embodiment, rendering effects, such as ray-tracing, may be implemented by visualization services 1220 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1220 may include an internal visualizer, cinematics, and/or other rendering or image processing capabilities or functionality (e.g., ray tracing, rasterization, internal optics, etc.).

In at least one embodiment, hardware 1122 may include GPUs 1222, AI system 1224, cloud 1226, and/or any other hardware used for executing training system 1104 and/or deployment system 1106. In at least one embodiment, GPUs 1222 (e.g., NVIDIA's TESLA and/or QUADRO GPUs) may include any number of GPUs that may be used for executing processing tasks of compute services 1216, AI services 1218, visualization services 1220, other services, and/or any of features or functionality of software 1118. For example, with respect to AI services 1218, GPUs 1222 may be used to perform pre-processing on imaging data (or other data types used by machine learning models), post-processing on outputs of machine learning models, and/or to perform inferencing (e.g., to execute machine learning models). In at least one embodiment, cloud 1226, AI system 1224, and/or other components of system 1200 may use GPUs 1222. In at least one embodiment, cloud 1226 may include a GPU-optimized platform for deep learning tasks. In at least one embodiment, AI system 1224 may use GPUs, and cloud 1226—or at least a portion tasked with deep learning or inferencing—may be executed using one or more AI systems 1224. As such, although hardware 1122 is illustrated as discrete components, this is not intended to be limiting, and any components of hardware 1122 may be combined with, or leveraged by, any other components of hardware 1122.

In at least one embodiment, AI system 1224 may include a purpose-built computing system (e.g., a super-computer or an HPC) configured for inferencing, deep learning, machine learning, and/or other artificial intelligence tasks. In at least one embodiment, AI system 1224 (e.g., NVIDIA's DGX) may include GPU-optimized software (e.g., a software stack) that may be executed using a plurality of GPUs 1222, in addition to DPUs, CPUs, RAM, storage, and/or other components, features, or functionality. In at least one embodiment, one or more AI systems 1224 may be implemented in cloud 1226 (e.g., in a data center) for performing some or all of AI-based processing tasks of system 1200.

In at least one embodiment, cloud 1226 may include a GPU-accelerated infrastructure (e.g., NVIDIA's NGC) that may provide a GPU-optimized platform for executing processing tasks of system 1200. In at least one embodiment, cloud 1226 may include an AI system(s) 1224 for performing one or more of AI-based tasks of system 1200 (e.g., as a hardware abstraction and scaling platform). In at least one embodiment, cloud 1226 may integrate with application orchestration system 1228 leveraging multiple GPUs to enable seamless scaling and load balancing between and among applications and services 1120. In at least one embodiment, cloud 1226 may tasked with executing at least some of services 1120 of system 1200, including compute services 1216, AI services 1218, and/or visualization services 1220, as described herein. In at least one embodiment, cloud 1226 may perform small and large batch inference (e.g., executing NVIDIA's TENSOR RT), provide an accelerated parallel computing API and platform 1230 (e.g., NVIDIA's CUDA), execute application orchestration system 1228 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1200.

FIG. 13A illustrates a data flow diagram for a process 1300 to train, retrain, or update a machine learning model, in accordance with at least one embodiment, such as with regards to generating animation data from audio data. In at least one embodiment, process 1300 may be executed using, as a non-limiting example, system 1200 of FIG. 12. In at least one embodiment, process 1300 may leverage services 1120 and/or hardware 1122 of system 1200, as described herein. In at least one embodiment, refined models 1312 generated by process 1300 may be executed by deployment system 1106 for one or more containerized applications in deployment pipelines 1210.

In at least one embodiment, model training 1114 may include retraining or updating an initial model 1304 (e.g., a pre-trained model) using new training data (e.g., new input data, such as customer dataset 1306, and/or new ground truth data associated with input data). In at least one embodiment, to retrain, or update, initial model 1304, output or loss layer(s) of initial model 1304 may be reset, or deleted, and/or replaced with an updated or new output or loss layer(s). In at least one embodiment, initial model 1304 may have previously fine-tuned parameters (e.g., weights and/or biases) that remain from prior training, so training or retraining 1114 may not take as long or require as much processing as training a model from scratch. In at least one embodiment, during model training 1114, by having reset or replaced output or loss layer(s) of initial model 1304, parameters may be updated and re-tuned for a new data set based on loss calculations associated with accuracy of output or loss layer(s) at generating predictions on new, customer dataset 1306 (e.g., image data 1108 of FIG. 11).

In at least one embodiment, pre-trained models 1206 may be stored in a data store, or registry (e.g., model registry 1124 of FIG. 11). In at least one embodiment, pre-trained models 1206 may have been trained, at least in part, at one or more facilities other than a facility executing process 1300. In at least one embodiment, to protect privacy and rights of patients, subjects, or clients of different facilities, pre-trained models 1206 may have been trained, on-premise, using customer or patient data generated on-premise. In at least one embodiment, pre-trained models 1206 may be trained using cloud 1226 and/or other hardware 1122, but confidential, privacy protected patient data may not be transferred to, used by, or accessible to any components of cloud 1226 (or other off premise hardware). In at least one embodiment, where a pre-trained model 1206 is trained at using patient data from more than one facility, pre-trained model 1206 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained model 1206 on-premise and/or off premise, such as in a datacenter or other cloud computing infrastructure.

In at least one embodiment, when selecting applications for use in deployment pipelines 1210, a user may also select machine learning models to be used for specific applications. In at least one embodiment, a user may not have a model for use, so a user may select a pre-trained model 1206 to use with an application. In at least one embodiment, pre-trained model 1206 may not be optimized for generating accurate results on customer dataset 1306 of a facility of a user (e.g., based on patient diversity, demographics, types of medical imaging devices used, etc.). In at least one embodiment, prior to deploying pre-trained model 1206 into deployment pipeline 1210 for use with an application(s), pre-trained model 1206 may be updated, retrained, and/or fine-tuned for use at a respective facility.

In at least one embodiment, a user may select pre-trained model 1206 that is to be updated, retrained, and/or fine-tuned, and pre-trained model 1206 may be referred to as initial model 1304 for training system 1104 within process 1300. In at least one embodiment, customer dataset 1306 (e.g., imaging data, genomics data, sequencing data, or other data types generated by devices at a facility) may be used to perform model training 1114 (which may include, without limitation, transfer learning) on initial model 1304 to generate refined model 1312. In at least one embodiment, ground truth data corresponding to customer dataset 1306 may be generated by training system 1104. In at least one embodiment, ground truth data may be generated, at least in part, by clinicians, scientists, doctors, practitioners, at a facility (e.g., as labeled clinic data 1112 of FIG. 11).

In at least one embodiment, AI-assisted annotation 1110 may be used in some examples to generate ground truth data. In at least one embodiment, AI-assisted annotation 1110 (e.g., implemented using an AI-assisted annotation SDK) may leverage machine learning models (e.g., neural networks) to generate suggested or predicted ground truth data for a customer dataset. In at least one embodiment, user 1310 may use annotation tools within a user interface (a graphical user interface (GUI)) on computing device 1308.

In at least one embodiment, user 1310 may interact with a GUI via computing device 1308 to edit or fine-tune (auto) annotations. In at least one embodiment, a polygon editing feature may be used to move vertices of a polygon to more accurate or fine-tuned locations.

In at least one embodiment, once customer dataset 1306 has associated ground truth data, ground truth data (e.g., from AI-assisted annotation, manual labeling, etc.) may be used by during model training 1114 to generate refined model 1312. In at least one embodiment, customer dataset 1306 may be applied to initial model 1304 any number of times, and ground truth data may be used to update parameters of initial model 1304 until an acceptable level of accuracy is attained for refined model 1312. In at least one embodiment, once refined model 1312 is generated, refined model 1312 may be deployed within one or more deployment pipelines 1210 at a facility for performing one or more processing tasks with respect to medical imaging data.

In at least one embodiment, refined model 1312 may be uploaded to pre-trained models 1206 in model registry 1124 to be selected by another facility. In at least one embodiment, his process may be completed at any number of facilities such that refined model 1312 may be further refined on new datasets any number of times to generate a more universal model.

FIG. 13B is an example illustration of a client-server architecture 1332 to enhance annotation tools with pre-trained annotation models, in accordance with at least one embodiment, such as with regards to generating animation data from audio data. In at least one embodiment, AI-assisted annotation tools 1336 may be instantiated based on a client-server architecture 1332. In at least one embodiment, annotation tools 1336 in imaging applications may aid radiologists, for example, identify organs and abnormalities. In at least one embodiment, imaging applications may include software tools that help user 1310 to identify, as a non-limiting example, a few extreme points on a particular organ of interest in raw images 1334 (e.g., in a 3D MRI or CT scan) and receive auto-annotated results for all 2D slices of a particular organ. In at least one embodiment, results may be stored in a data store as training data 1338 and used as (for example and without limitation) ground truth data for training. In at least one embodiment, when computing device 1308 sends extreme points for AI-assisted annotation 1110, a deep learning model, for example, may receive this data as input and return inference results of a segmented organ or abnormality. In at least one embodiment, pre-instantiated annotation tools, such as AI-Assisted Annotation Tool 1336B in FIG. 13B, may be enhanced by making API calls (e.g., API Call 1344) to a server, such as an Annotation Assistant Server 1340 that may include a set of pre-trained models 1342 stored in an annotation model registry, for example. In at least one embodiment, an annotation model registry may store pre-trained models 1342 (e.g., machine learning models, such as deep learning models) that are pre-trained to perform AI-assisted annotation on a particular organ or abnormality. These models may be further updated by using training pipelines 1204. In at least one embodiment, pre-installed annotation tools may be improved over time as new labeled clinic data 1112 is added.

What is claimed is:

1. A method comprising:
responsive to determining that audio data in an audio data queue satisfies a first criterion, generating a delay indicator;
receiving updates to the audio data queue; and
responsive to determining that the audio data in the audio data queue satisfies a second criterion, causing the audio data in the audio data queue and animation data in an animation data queue to play in accordance with the delay indicator to maintain synchronization between the audio data and the animation data.

2. The method of claim 1, further comprising:
receiving the animation data from a server device, the animation data having been generated by an artificial intelligence (AI) model based on processing of the audio data; and
storing the animation data in the animation data queue.

3. The method of claim 1, further comprising:
receiving the audio data and the animation data from a server device, the audio data and the animation data having been output by an artificial intelligence (AI) model based on processing of a prompt;
storing the animation data in the animation data queue; and
storing the audio data in the audio data queue.

4. The method of claim 1, further comprising:
receiving, by a client device, a prompt associated with a three-dimensional (3D) animation model;
sending the prompt to a server device for processing by an artificial intelligence (AI) model that is trained to generate animation data for the 3D animation model;
receiving, from the server device, the animation data and corresponding audio data, wherein the animation data and the corresponding audio data correspond to output from the AI model;
storing the received animation data in the animation data queue; and
storing the received audio data in the audio data queue.

5. The method of claim 4, wherein the prompt is at least one of: a textual prompt or an audio prompt.

6. The method of claim 1, wherein causing the audio data in the audio data queue and the corresponding animation data in the animation data queue to play comprises:
applying the corresponding animation data to a three-dimensional (3D) animation model, wherein the 3D animation model is provided for display in a user interface of the client device; and
causing the audio data in the audio data queue to playback on a client device.

7. The method of claim 1, wherein causing the audio data in the audio data queue and the corresponding animation data in the animation data queue to play in accordance with the delay indicator comprises:
identifying, based on the delay indicator, a time delay; and
applying the time delay to a play start time associated with the audio data.

8. The method of claim 1, further comprising:
responsive to determining that the audio data in the audio data queue satisfies the first criterion, causing silent audio to playback on a client device.

9. The method of claim 1, wherein the method is implemented by a web browser comprising a first context and a second context, wherein causing the audio data in the audio data queue to play is performed in the first context using a first thread and a second thread, and wherein causing the animation data in the animation data to play is performed in the second context using a third thread, a fourth thread, and a fifth thread.

10. The method of claim 9, wherein the first thread of the first context of the web browser reads the audio data from the audio data queue and generates the delay indicator in response to determining that the audio data in the audio data queue satisfies the first criterion, wherein the first thread of the first context sends, to the fourth thread of the second context of the web browser, an audio delay message comprising the delay indicator, and wherein the fourth thread of the second context stores a time delay associated with the delay indicator.

11. The method of claim 9, wherein the third thread of the second context of the web browser receives, from a server device, the audio data and the animation data, wherein the third thread of the second context sends the received audio data to the second thread of the first context, wherein the second thread of the first context stores the received audio data in the audio data queue, and wherein the third thread of the second context stores the received animation data in the animation data queue.

12. The method of claim 9, wherein the first thread of the first context of the web browser causes the audio data in the audio data queue to play, and wherein the fifth thread of the second context of the web browser causes the corresponding animation data in the animation data queue to play in accordance with the delay indicator.

13. A system comprising:
one or more processing units to:
responsive to determining that audio data in an audio data queue satisfies a first criterion, generate a delay indicator;
receive updates to the audio data queue; and
responsive to determining that the audio data in the audio data queue satisfies a second criterion, cause the audio data in the audio data queue and animation data in an animation data queue to play in accordance with the delay indicator to maintain synchronization between the audio data and the animation data.

14. The system of claim 13, wherein the one or more processing units further to:
receive the animation data from a server device, the animation data having been generated by an artificial intelligence (AI) model based on processing of the audio data; and
store the animation data in the animation data queue.

15. The system of claim 13, wherein the one or more processing units further to:
receive the audio data and the animation data from a server device, the audio data and the animation data having been output by an artificial intelligence (AI) model based on processing of a prompt;
store the animation data in the animation data queue; and
store the audio data in the audio data queue.

16. The system of claim 13, wherein the one or more processing units further to:
receive a prompt associated with a three-dimensional (3D) animation model, wherein the prompt is at least one of: a textual prompt or an audio prompt;
send the prompt to a server device for processing by an artificial intelligence (AI) model that is trained to generate animation data for the 3D animation model;
receive, from the server device, the animation data and corresponding audio data, wherein the animation data and the corresponding audio data correspond to output from the AI model;
store the received animation data in the animation data queue; and
store the received audio data in the audio data queue.

17. The system of claim 13, wherein the one or more processing units further to:
apply the corresponding animation data to a three-dimensional (3D) animation model, wherein the 3D animation model is provided for display in a user interface of a client device; and
cause the audio data in the audio data queue to playback on the client device.

18. The system of claim 13, wherein to cause the audio data in the audio data queue and the corresponding animation data in the animation data queue to play in accordance with the delay indicator, the one or more processing units further to:
identifying, based on the delay indicator, a time delay; and
applying the time delay to a play start time associated with the audio data.

19. The system of claim 13, wherein the one or more processing units further to:
responsive to determining that the audio data in the audio data queue satisfies the first criterion, cause silent audio to playback on a client device.

20. One or more processors comprising:
circuitry to cause a synchronized presentation of audio data from an audio data queue with animation data from an animation data queue, wherein the synchronized presentation is presented in accordance with a delay indicator computed in response to determining that the audio data in the audio data queue satisfies a first criterion and updated in response to determining that the audio data in the audio data queue satisfies a second criterion after the audio data queue has been updated with new audio data.
